(19) United States
(12) Patent Application Publication
(10) Pub. No.: US 2024/0193456 A1
(43) Pub. Date: Jun. 13, 2024

(54) QUANTUM INFORMATION PROCESSING APPARATUS AND QUANTUM INFORMATION PROCESSING APPARATUS SYSTEM

(71) Applicant: SONY GROUP CORPORATION, TOKYO (JP)

(72) Inventors: TOSHIYUKI KOBAYASHI, TOKYO (JP); HIROMI CAPORALE, TOKYO (JP)

(21) Appl. No.: 18/551,410

(22) PCT Filed: Feb. 14, 2022
(86) PCT No.: PCT/JP2022/005589

§ 371 Date: Sep. 20, 2023

(30) Foreign Application Priority Data
Mar. 31, 2021 (JP) 2021-061831

(51) Int. Cl. G06N 10/40; G06N 10/20

(52) U.S. Cl. CPC G06N 10/40; G06N 10/20

(57) ABSTRACT

Provided is a quantum information processing apparatus and a quantum information processing apparatus system including: a quantum module array in which a plurality of quantum modules are arranged in an array; a control module configured to perform an operation of forming entanglement between the quantum modules and control of measurement of a quantum state of the quantum modules; and a driving apparatus configured to rotate at least one of the quantum module array and the control module.

### FIELD

The present disclosure relates to a quantum information processing apparatus and a quantum information processing apparatus system.

### BACKGROUND

A quantum computer using a quantum state such as quantum entanglement is known. Furthermore, an error-tolerant quantum computer that automatically corrects errors occurring in a quantum state or a quantum bit has been proposed (see, for example, Non Patent Literatures 1 and 2). The error-tolerant quantum computer is a quantum computer in which a logical quantum bit composed of a plurality of physical quantum bits is defined and controlled to execute a logical operation between the logical quantum bits. Further, in order to realize an operation speed higher than that of a classical computer in practical problems, one million quantum module is typically required.

### CITATION LIST

### Non Patent Literature

Non Patent Literature 1: “Photonic Architecture for Scalable Quantum Information Processing in Diamond”, Phys. Rev. X 4, 031022 (2014)
Non Patent Literature 2: “Percolation based architecture for cluster state creation using photon-mediated entanglement between atomic memories”, npj Quantum Information 5:104 (2019)

### SUMMARY

### Technical Problem

However, in the above-described related art, since a density of mounting is low and sufficient integration cannot be performed, there is a problem that an apparatus becomes very large.

Therefore, the present disclosure proposes a quantum information processing apparatus and a quantum information processing apparatus system capable of downsizing the apparatus.

### Solution to Problem

According to the present disclosure, a quantum information processing apparatus includes: a quantum module array in which a plurality of quantum modules are arranged in an array; a control module configured to perform an operation of forming entanglement between the quantum modules and control of measurement of a quantum state of the quantum modules; and a driving apparatus configured to rotate at least one of the quantum module array and the control module.

### BRIEF DESCRIPTION OF DRAWINGS

FIG. 1 is a diagram illustrating a configuration example of a quantum information processing apparatus according to a first embodiment of the present disclosure.

FIG. 2 is a top view illustrating a configuration example of a quantum module array.

FIG. 3 is a cross-sectional view illustrating a configuration example of a quantum module array.

FIG. 4 is a diagram illustrating an example of a graph state of a quantum bit on which an error-tolerant quantum calculation can be executed.

FIG. 5 is a diagram illustrating an example of an array state of quantum modules in a quantum module array designed such that the graph state of FIG. 4 can be formed.

FIG. 6 is an enlarged view of a region A in FIG. 5.

FIG. 7 is a diagram illustrating an operation state of a quantum module array in an operation step 1.

FIG. 8 is a diagram illustrating an operation state of a quantum module array in an operation step 2.

FIG. 9 is a diagram illustrating an operation state of a quantum module array in an operation step 3.

FIG. 10 is a diagram illustrating an operation state of a quantum module array in an operation step 4.

FIG. 11 is a diagram illustrating an operation state of a quantum module array in an operation step 5.

FIG. 12 is a diagram illustrating an operation state of a quantum module array in an operation step 6.

FIG. 13 is a top view illustrating a configuration example of a control module.

FIG. 14 is a diagram illustrating functional block assignment in a control module.

FIG. 15 is a diagram of an annular second functional block developed in a rectangular shape.

FIG. 16 is an example of an enlarged view of a remote entanglement forming module.

FIG. 17 is an example of an enlarged view of a remote entanglement forming module.

FIG. 18 is an enlarged view of a high-frequency magnetic field application module.

FIG. 19 is an enlarged view of a light irradiation module.

FIG. 20 is an enlarged view of a reflectance measurement module.

FIG. 21 is a cross-sectional view of a remote entanglement forming module.

FIG. 22A is a diagram (part 1) illustrating channel assignment of radio waves and microwaves.

FIG. 22B is a diagram (part 2) illustrating channel assignment of radio waves and microwaves.

FIG. 23 is a diagram illustrating microwave channel assignment of a quantum module row.

FIG. 24 is a diagram illustrating an operation in a first functional block.

FIG. 25 is a diagram illustrating an operation in electron spin measurement.

FIG. 26 is a diagram schematically illustrating an operation in a first functional block.

FIG. 27 is a diagram schematically illustrating a phase correction operation.

FIG. 28 is a diagram schematically illustrating an operation of performing measurement and initialization of an X basis of a nuclear spin.

FIG. 29 is a diagram schematically illustrating an operation of performing measurement and initialization of a Z basis of a nuclear spin.

FIG. 30 is a diagram illustrating an operation in a second functional block.

FIG. 31 is a diagram schematically illustrating an operation in a second functional block.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

### First Embodiment

### [Configuration of Distributed Error-Tolerant Quantum Computer According to First Embodiment]

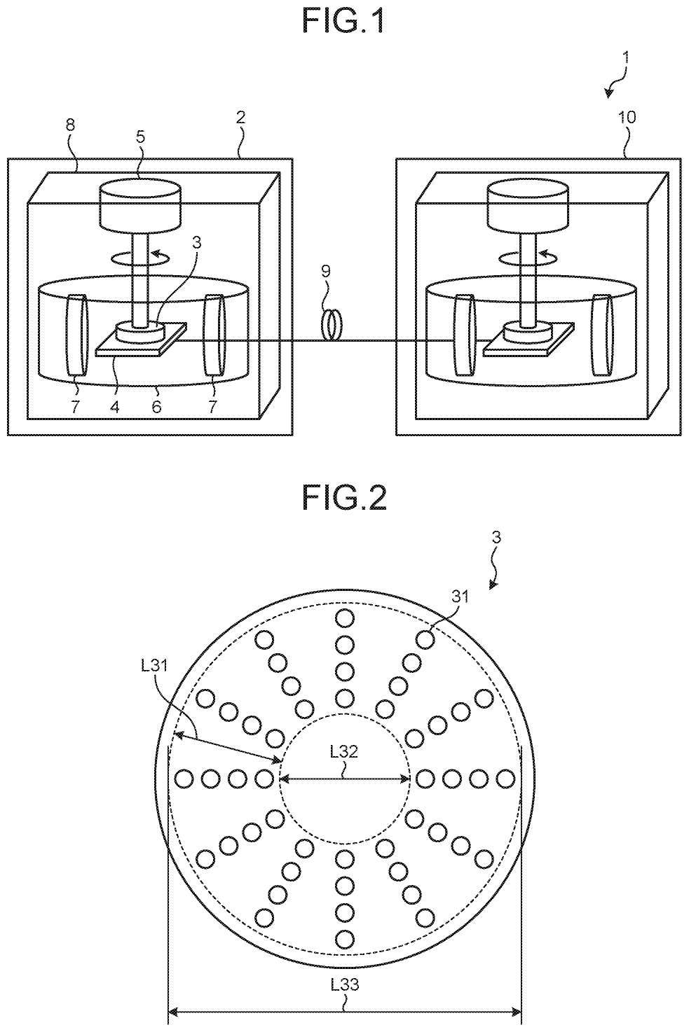

FIG. 1 is a diagram illustrating a configuration example of a quantum information processing apparatus according to a first embodiment of the present disclosure. As illustrated in FIG. 1, a distributed error-tolerant quantum computer 1 as a quantum information processing apparatus system includes a quantum computer 2 as a quantum information processing apparatus, an optical fiber 9, and a quantum computer 10. Since the quantum computer 2 and the quantum computer 10 may have the same configuration, the description of the quantum computer 10 is omitted.

The distributed error-tolerant quantum computer 1 is configured by coupling control modules 4 of the quantum computer 2 and the quantum computer 10, which are error-tolerant quantum computers having the number of quantum modules on a scale that can complete a specific task, with the optical fiber 9. The specific task means, for example, generation of a high-fidelity quantum state required for a distributed error-tolerant quantum computer.

The quantum computer 2 and the quantum computer 10 may be quantum computers having a small number of quantum modules and incapable of completing a specific task. In that case, although the number of optical fibers coupling the quantum computer 2 and the quantum computer 10 increases, it is possible to realize a distributed error-tolerant quantum computer.

In addition, a distributed error-tolerant quantum computer may be realized by coupling three or more quantum computers with an optical fiber.

In Non Patent Literature 1, a plurality of quantum modules in which a nitrogen-vacancy (NV) center (lattice defect) of diamond and an optical resonator are combined are prepared, and quantum entanglement between the quantum modules is formed via a single photon by coupling the quantum modules with an optical fiber. Therefore, as many optical fibers as the number of quantum modules are required. Further, in order to realize an error-tolerant quantum computer having the number of quantum modules of one million or more, coupling using one million or more optical fibers is required, and the apparatus becomes very large.

On the other hand, according to the distributed error-tolerant quantum computer 1 of the first embodiment, the apparatus can be significantly downsized as compared with the technique of Non Patent Literature 1.

In addition, in Non Patent Literature 2, a plurality of quantum modules are mounted in an optical integrated circuit, and quantum entanglement between the quantum modules is formed via an optical waveguide. In this case, coupling by an optical fiber is not necessary, but many phase modulators are required in the optical integrated circuit in order to switch a path of light. In a case where an error-tolerant quantum computer having the number of quantum modules of one million or more is to be realized by using a 300 mm wafer that is currently generally used, it is very difficult to fit all the configurations in the wafer. In addition, in the technique of Non Patent Literature 2, since it is necessary to switch the optical path for each operation, power consumption is large.

On the other hand, according to the distributed error-tolerant quantum computer 1 of the first embodiment, it is possible to realize a distributed error-tolerant quantum computer having the number of quantum modules of one million or more in a chip area of a realistic size. In addition, since a phase modulator is not required, a distributed error-tolerant quantum computer with a low power consumption, downsized, and low cost can be realized.

### [Configuration of Quantum Computer According to First Embodiment]

The quantum computer 2 includes a quantum module array 3, a control module 4, a driving apparatus 5, a magnetic field application apparatus 6, an oscillating magnetic field generating apparatus 7, and a refrigerator 8.

In the quantum computer 2, the quantum module array 3 and the control module 4 are disposed facing each other, and the driving apparatus 5 rotates the quantum module array 3. As a result, at a predetermined timing, a predetermined operation module of the control module 4 and a predetermined quantum module of the quantum module array 3 come close to each other. Further, at this timing when the modules are close to each other, the quantum state of the quantum module including entanglement formation between the quantum modules can be operated or measured by irradiating the quantum module with an electromagnetic field such as a single photon, a microwave, a radio wave, or a laser beam from the operation module. The quantum computer 2 executes quantum calculation by this operation and measurement.

### [Configuration of Quantum Module Array According to First Embodiment]

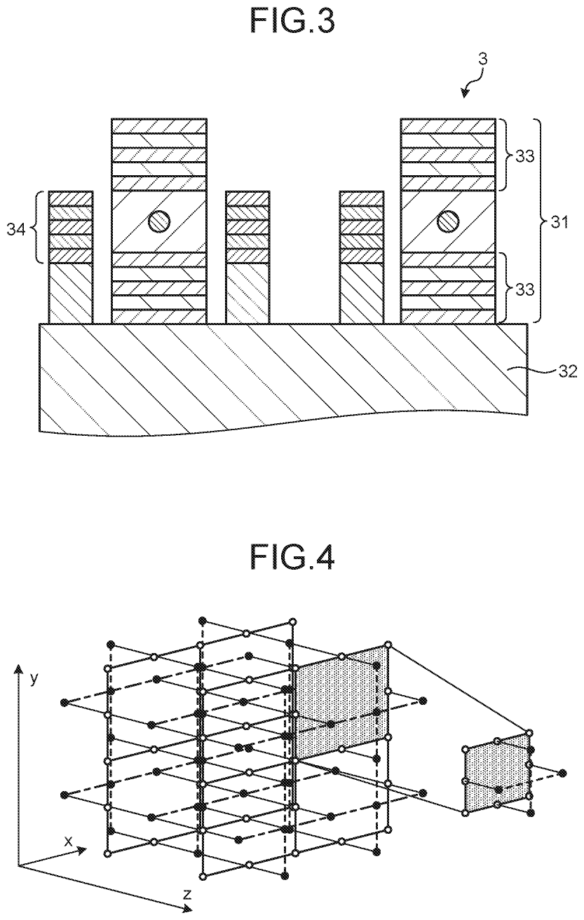

In the quantum module array 3, a plurality of quantum modules are arranged in an annular array. FIG. 2 is a top view illustrating a configuration example of the quantum module array. FIG. 3 is a cross-sectional view illustrating a configuration example of the quantum module array. The quantum module array 3 includes a plurality of quantum modules 31 arranged two-dimensionally, a substrate 32 on which the quantum modules 31 are disposed, a dielectric multilayer film 33, and a magnetic multilayer film 34 disposed in the vicinity of the quantum modules 31 and supported by a nonmagnetic support. A pair of dielectric multilayer films 33 constitutes an optical resonator.

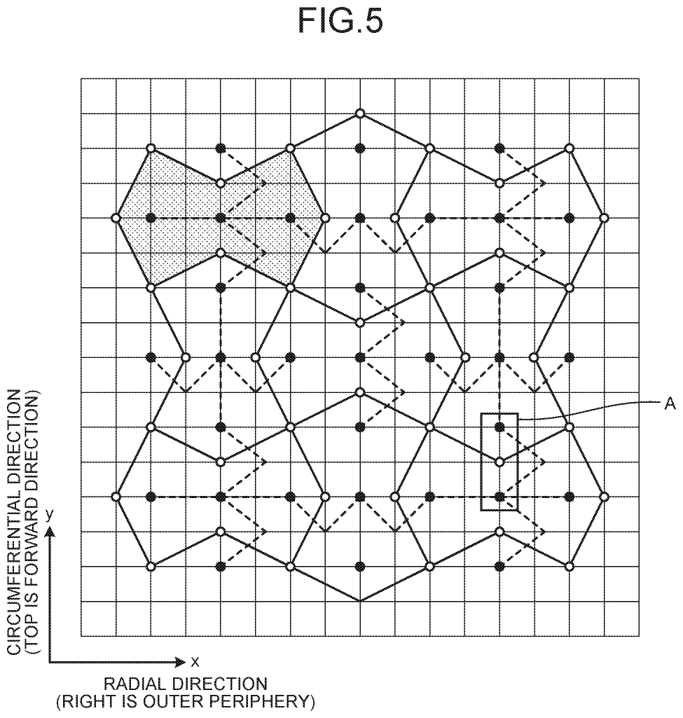

The quantum modules 31 are radially arranged such that an interval becomes wider toward an outer periphery. Note that an arrangement pattern of the quantum module 31 is not particularly limited as long as quantum calculation can be executed. In addition, the arrangement pattern of the quantum module 31 may be an arbitrary layout as long as error correction is unnecessary. For example, an arrangement pattern obtained by developing the disposition used in Non Patent Literatures 1 and 2 in which two layers of a prime plane and a dual plane of Raussendorf lattice used for mounting a three-dimensional topological error correction code are two-dimensionally arranged in an annular shape may be used. For example, an xy plane including white circles in FIG. 4 is the prime plane, and a plane including black circles is the dual plane. Since the white circle plane and the black circle plane are equivalent, the former may be a dual plane, and the latter may be a prime plane.

Furthermore, the quantum module arrays can be stacked to be used as one quantum module array 3. In this case, the arrangement of the quantum modules 31 is a three-dimensional array. By arranging the quantum modules 31 in a three-dimensional arrangement, the quantum modules 31 can be integrated with higher density.

FIG. 5 is a diagram illustrating an example of an array state of the quantum modules in the quantum module array designed such that the graph state of FIG. 4 can be formed. A hatched region in FIG. 4 and a hatched region in FIG. 5 represent regions corresponding to each other.

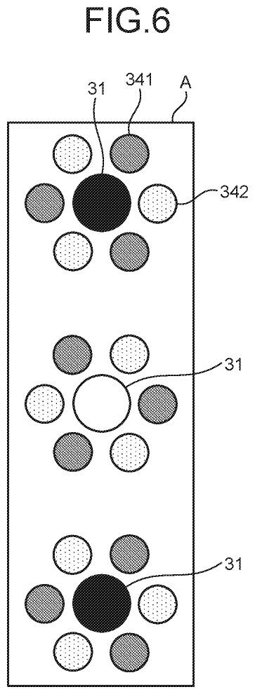

In order to individually operate the quantum module 31, a resonance frequency of the optical resonator of the quantum module 31 may be changed. In the following description, it is assumed that the resonance frequency of the optical resonator of the quantum module 31 is equal to an optical transition frequency, and in order to distinguish from a resonance frequency of a two-level system such as an electron spin and a nuclear spin, the resonance frequency of the optical resonator of the quantum module 31 is described as an optical transition frequency. Specifically, a spatial distribution of a magnetic field may be changed by forming a fine magnetization pattern of a magnetic body on the surface or inside of the quantum module array 3 and locally switching the magnetization by light. FIG. 6 is an enlarged view of a region A in FIG. 5. As illustrated in FIG. 6, magnetic bodies 341 and 342 having different amounts of change in magnetization are disposed around the quantum module 31.

Since the resonance frequency (hereinafter, described as a resonance frequency) of the two-level system of the quantum module 31 depends on a magnitude of the magnetic field, by changing the resonance frequencies of the quantum module 31 to be operated and the quantum module 31 not to be operated (not to be operated), the quantum module 31 to be operated by radio waves or microwaves can be selected. As a result, since the plurality of quantum modules 31 can be operated simultaneously by radio waves or microwaves of the same frequency, the number of quantum modules 31 that can be operated during one rotation of the quantum module array 3 can be increased. Note that in the related art, a large gradient magnetic field has to be formed, and a different frequency has to be assigned to each quantum bit. Therefore, even in a case where 100 channels can be used, the number of quantum bits that can be operated by selecting an operation target is up to 100. When magnetic bodies having different amounts of change in magnetization are combined, a degree of freedom in resonance frequency setting can be increased.

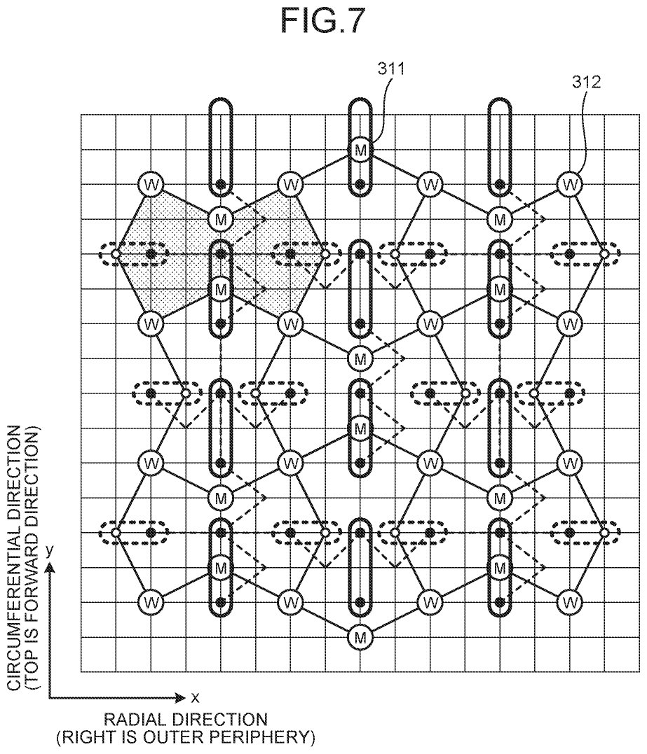

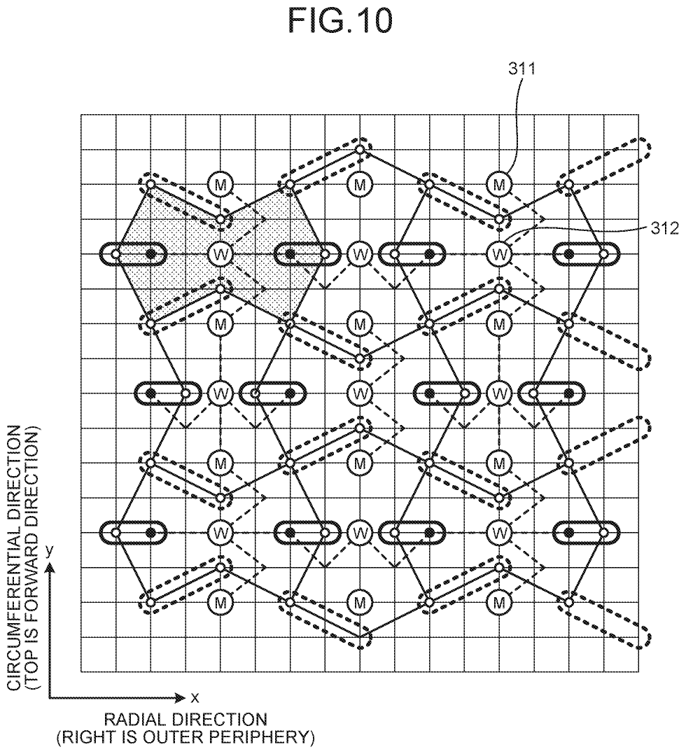

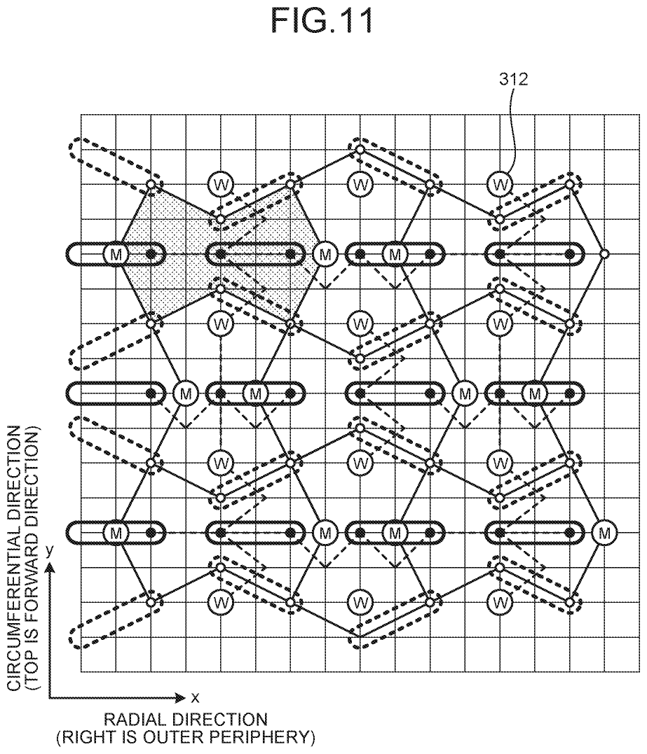

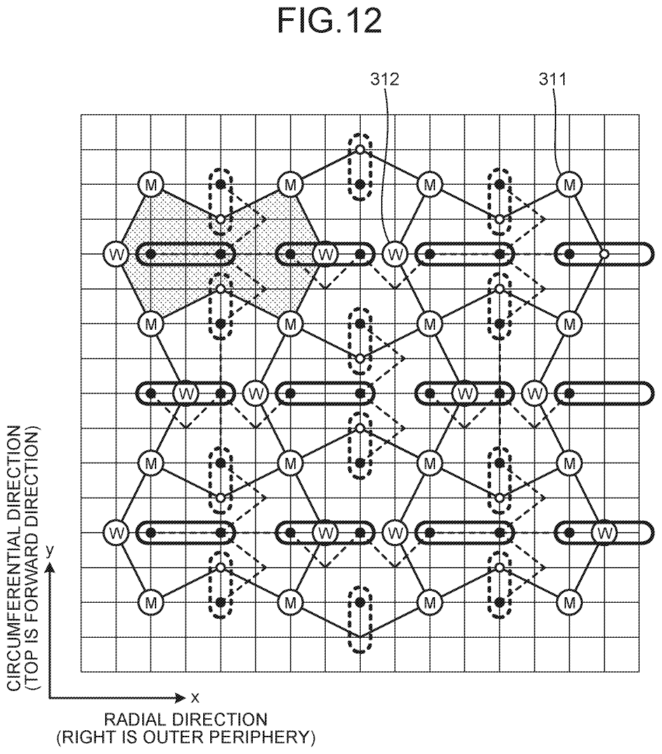

FIGS. 7 to 12 are diagrams illustrating an operation state of the quantum module array in operation steps 1 to 6. In FIGS. 7 to 12, a quantum module 311 to be measured for measuring the nuclear spin is represented by M inside a circle, and a non-operation quantum module 312 not to be measured is represented by W inside a circle. In addition, each of solid ellipses and broken ellipses represents a pair of quantum modules 31 in which entanglement of nuclear spins is formed. Further, six operation steps illustrated in FIGS. 7 to 12 are repeated to execute the error-tolerant quantum calculation by the distributed error-tolerant quantum computer 1.

The quantum module 31 includes an optical resonator including a pair of dielectric multilayer films 33, a communication quantum bit combined with the optical resonator via photons, and a data quantum bit combined with the communication quantum bit. A reflectance R of the optical resonator changes according to a state of the communication quantum bit (see Non Patent Literature 1). When a cooperativity of the quantum module 31 is C, a frequency of light is ω, an optical transition frequency of an electron in a state |0> is ω₀, an optical transition frequency of an electron in a state |1> is ω₁, δ₀=|ω₀−ω|, δ₁=|ω₁−ω|, and a spontaneous emission rate of an excited state is γ, the quantum module can be represented by Formula (1) with i=0 or 1.

$${R}_{i} = 1 - \frac{1 + 4 C + {( {δ}_{i} / γ )}^{2}}{1 + 4 C + 4 {C}^{2} + {( {δ}_{i} / γ )}^{2}} \qquad ( 1 )$$

A resonance frequency ω_{c} of the optical resonator is ω_{c} to ω to ω₀, and may be selected to increase a reflectance contrast ratio R₁/R₀. As an example, when electrons at a diamond NV⁻ center are used for communication quantum bits, C=20, δ=2π×2.71 GHz, and γ=about 2π×6 MHz. In addition, the communication quantum bits may be combined with a plurality of data quantum bits. A fidelity of entanglement can be increased by a protocol such as entanglement purification. When a communication quantum bit is combined with a plurality of data quantum bits, a plurality of point defects or quantum dots may be arranged.

Note that one optical resonator may be used in common for the entire quantum module array 3. In this case, manufacturing is easy. In addition, one optical resonator may be independently disposed for each quantum module 31. In this case, an error rate decreases.

The quantum module 31 is formed by using, for example, a nitrogen vacancy (NV) center (lattice defect) of diamond, but the communication quantum bit may be formed by using localized electrons in a solid having a long coherence time. As the quantum module 31, for example, in light emitting point defects having discrete energy levels such as diamond, silicon carbide, silicon, rare earth oxide, gallium nitride, aluminum nitride, boron nitride, oxide (for example, YVO₄, Y₂SiO₅, YAG, and TiO₂), and transition metal chalcogenide (for example, MoSe₂, WSe₂, MoS₂, and WS₂), four levels obtained by combining two levels used as quantum bits and two levels of their excited states can be selected and used as communication quantum bits. In addition, as the quantum module 31, in a light emitting quantum dot of a semiconductor material (for example, GaAs, AlAs, InAs, InSb, GaN, AlN, and mixed crystals thereof), four levels obtained by combining two levels used as quantum bits and two levels of their excited states can be selected and used as communication quantum bits.

The quantum module 31 selects two levels to be used as quantum bits in the above-described material system, and can configure a data quantum bit by using the two levels. In addition, the quantum module 31 may select two levels to be used as quantum bits in a non-light emitting point defect or a quantum dot, and configure a data quantum bit by using the two levels. Furthermore, the quantum module 31 may select two levels to be used as quantum bits in the nuclear spin, and configure data quantum bits using the two levels.

The substrate 32 may be arbitrary substrate having a disk shape, and is made of, for example, silicon, quartz, or glass. By forming the substrate 32 from these materials, flatness and rigidity can be increased, such that the error rate can be reduced. In addition, since the substrate 32 can be formed by an existing apparatus, manufacturing is easy. Furthermore, since the substrate 32 has a disk shape, a rotation speed is stabilized, such that the error rate can be reduced.

The optical resonator may be a Fabry-Perot type vertical optical resonator including a pair of dielectric multilayer films 33. A material, a refractive index, a film thickness, the number of layers, and a shape of the dielectric multilayer film 33 are not particularly limited as long as a desired reflectance contrast ratio R₁/R₀ is realized. The dielectric multilayer film 33 includes, for example, a dielectric multilayer film flat mirror of SiO₂/TiO₂ which is easily manufactured. In addition, the dielectric multilayer film 33 may have a concave shape. By processing the surface of the diamond into a convex surface, disposing an intermediate member on the convex surface between the diamond and the dielectric multilayer film 33, or making a space between the diamond and the dielectric multilayer film 33 hollow, the shape of the dielectric multilayer film 33 can be made concave. As a result, a light confinement efficiency can be improved and the error rate can be reduced. Furthermore, when the error rate decreases, the number of trials for entanglement formation and measurement decreases, such that calculation can be speeded up.

In addition, among the pair of dielectric multilayer films 33, the dielectric multilayer film 33 located on the control module 4 side may be provided in the control module 4. In this case, a photon recovery efficiency is improved, and a probability of successful entanglement formation is increased, such that the calculation can be speeded up. Furthermore, it is possible to improve an error rate when measuring a communication quantum bit state.

In addition, the dielectric multilayer film 33 constituting the vertical optical resonator may be replaced with a two-dimensional photonic crystal. In this case, since the dielectric multilayer film is unnecessary, the operation module of the control module 4 and a four-level system can be brought close to each other, and a mounting density of the quantum module 31 can be increased.

The magnetic multilayer film 34 includes a magnetic body disposed close to a physical system used as a quantum bit constituting the quantum module 31. A material of the magnetic body is not particularly limited as long as magnetization can be switched by light. As a principle of switching the magnetization, for example, a phase transition from a ferromagnetic body to a paramagnetic body due to a temperature rise exceeding a Curie temperature, magnetization inversion according to intensity of a light pulse in an exchange-combining film in which ferromagnetic materials having different Curie temperatures are stacked, light-induced magnetization in a magneto-optical complex, or the like can be used. In addition, a magnetic pattern for forming a spatial distribution of the magnetic field may be formed depending on a presence or absence of a thin film, or may be formed by partially magnetizing the thin film with a laser pulse. The resonance frequency of the quantum module 31 is determined based on the combined magnetic field at the position of each quantum module 31 of the external magnetic field and a leakage magnetic field by the magnetic body pattern.

### [Configuration of Control Module According to First Embodiment]

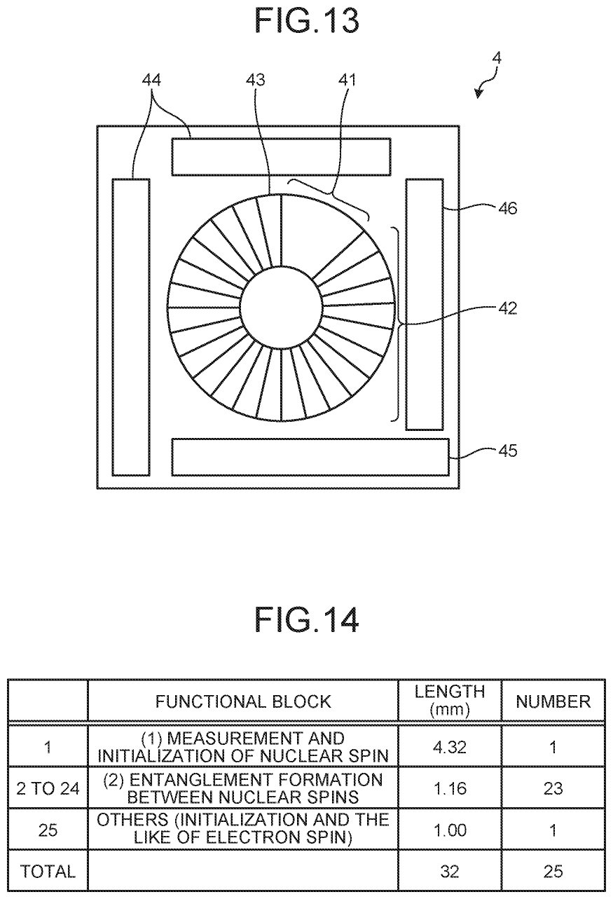

The control module 4 performs an operation of forming entanglement between the quantum modules and control of measurement of a quantum state of the quantum module. FIG. 13 is a top view illustrating a configuration example of the control module. FIG. 13 is a diagram illustrating functional block assignment in the control module. As illustrated in FIG. 13, the control module 4 includes a first functional block 41, a second functional block 42, and a third functional block 43 which are arranged in an annular shape to face the quantum module array 3, and a control circuit 44, an optical converter array 45, and a communication interface 46 which are disposed on the outer peripheries of the first functional block 41 to the third functional block 43.

A plurality of operation modules included in each of the first functional block 41 to the third functional block 43 of the control module 4 are disposed in an annular shape to be able to execute generation and measurement of a cluster state required for the error-tolerant quantum calculation.

### [Configuration of First Functional Block According to First Embodiment]

FIG. 14 is a diagram illustrating functional block assignment in the control module. As illustrated in FIG. 14, the first functional block 41 executes measurement and initialization of the nuclear spin.

### [Configuration of Second Functional Block According to First Embodiment]

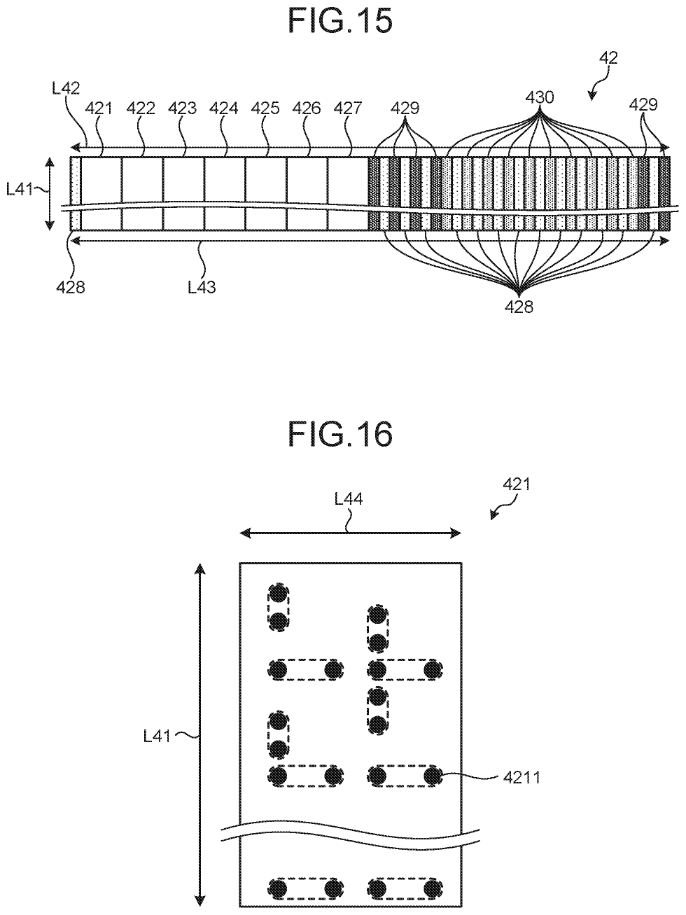

As illustrated in FIG. 14, the second functional block 42 performs entanglement formation between the nuclear spins. FIG. 15 is an explanatory diagram in which the second functional block 42 that actually has an annular shape is developed in a pseudo rectangular shape, and the second functional block 42 correctly has the annular shape illustrated in FIG. 13. As illustrated in FIG. 15, the second functional block 42 includes remote entanglement forming modules 421 to 427 as the operation modules, a high-frequency magnetic field application module 428, a light irradiation module 429, and a reflectance measurement module 430.

### [Configuration of Remote Entanglement Forming Module According to First Embodiment]

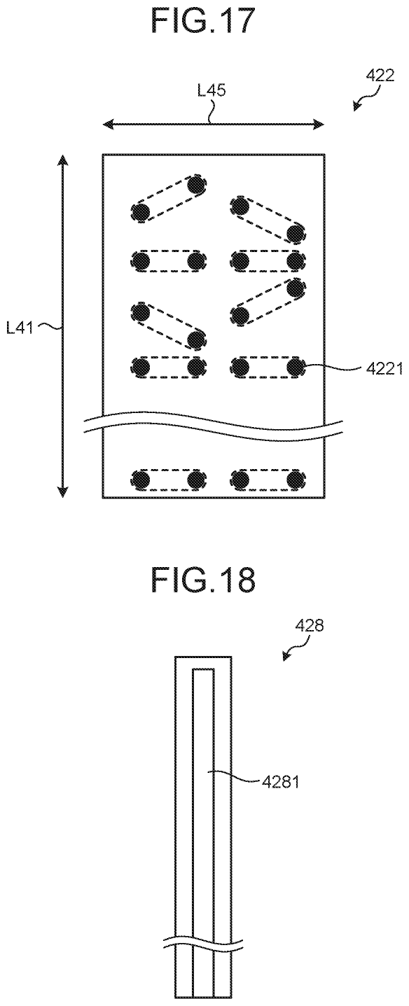

The remote entanglement forming module 421 performs an operation of forming entanglement between the quantum modules 31. FIGS. 16 and 17 are examples of enlarged views of the remote entanglement forming module.

As illustrated in FIG. 16, the remote entanglement forming module 421 has a single photon input/output port 4211 that inputs and outputs a single photon. The remote entanglement forming module 421 performs the operations in an operation step 1 illustrated in FIG. 7. Therefore, the single photon input/output port 4211 is disposed at a position corresponding to the operation step 1. The remote entanglement forming module 421 has a single photon source, a single photon detector, an optical waveguide, a concentrator, and a beam splitter.

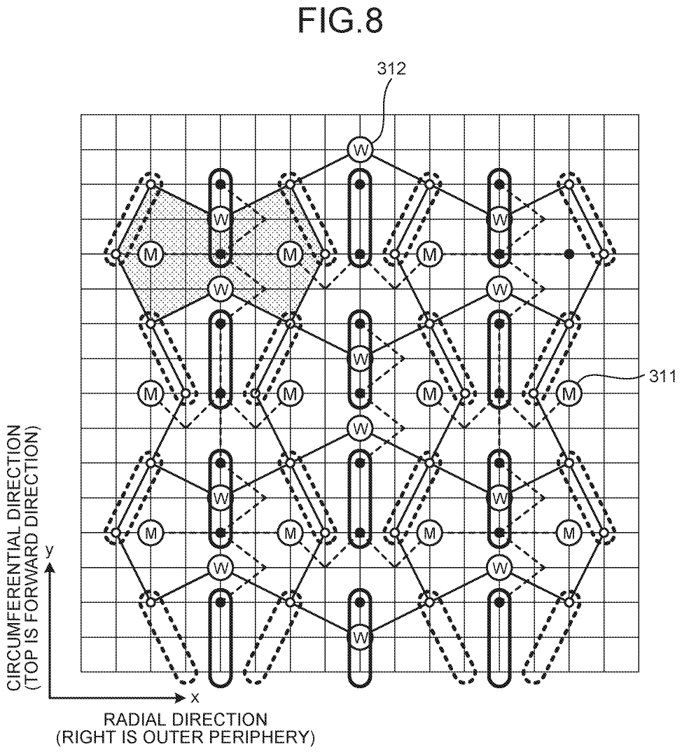

As illustrated in FIG. 17, the remote entanglement forming module 422 has a single photon input/output port 4221 that inputs and outputs a single photon. The remote entanglement forming module 422 performs operations in an operation step 2 illustrated in FIG. 8. Therefore, the single photon input/output port 4211 is disposed at a position corresponding to the operation step 2.

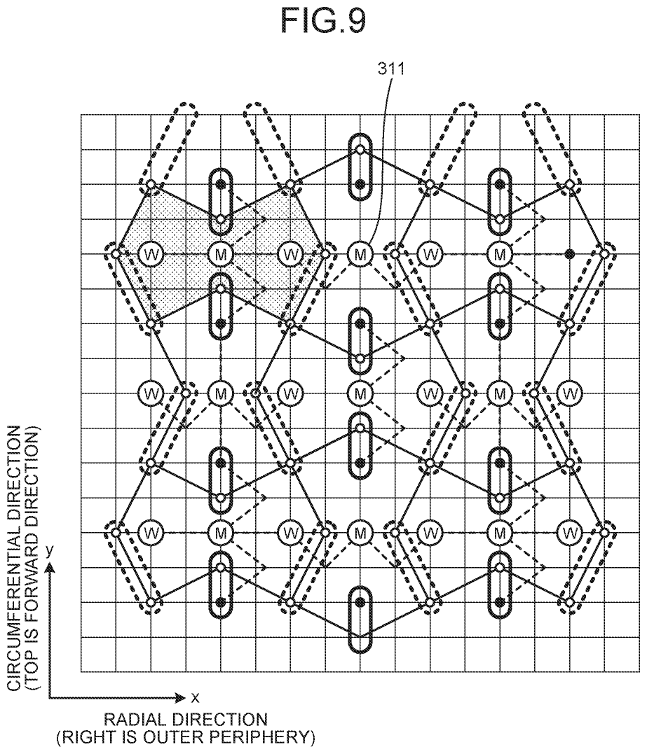

Similarly, the remote entanglement forming modules 423 to 427 perform operations in operation steps 3 to 6 illustrated in FIGS. 9 to 12, respectively. As such, the single photon input/output ports of the remote entanglement forming modules 423 to 427 are disposed at positions corresponding to the operation steps 3 to 6, respectively.

The single photon source can be realized, for example, by using single photon emission of lattice defects at an NV center. In addition, the single photon source may also be realized by using single photon emission of quantum dots. In this case, the lattice defect or the quantum dot is caused to emit light by photoexcitation or current injection. A light source of excitation light may be installed outside the control module 4, and may be introduced into the control module 4 by an optical fiber. In addition, the single photon source may also be realized by using spontaneous parametric down-conversion (SPDC: Spontaneous parametric down-conversion) or four-wave mixing (SFWM: Spontaneous Four-Wave Mixing) in non-linear optical materials. Specifically, when pump light is incident on the non-linear optical material, a single photon pair is obtained. Further, by using one single photon as a command and using only the other single photon, a single photon source having a small photon loss (pulse in which no photon exists) can be realized. Note that a single photon source can be similarly realized in other operation modules.

In addition, the remote entanglement forming module 421 also has a single photon detector that detects a single photon, an optical waveguide that transmits the single photon, a beam splitter that demultiplexes the single photon of a predetermined frequency, and a concentrator that concentrates the demultiplexed single photon on a pair of quantum modules forming entanglement. The single photon detector may be realized by using a superconducting single photon detector (SSPD: Superconducting Single Photon Detector) or a single photon avalanche diode (SPAD: Single Photon Avalanche Diode). The concentrator can be realized by using an on-chip lens, a grating coupler, a concave mirror of a waveguide end, a photonic crystal, a metamaterial, a metasurface, or the like. Note that a single photon detector and a concentrator can be similarly realized in other operation modules.

After preparing the two communication quantum bits A and B to be entangled in an overlapping state of (|0_{A(B)}>+|1_{A(B)}>)/√2 respectively, a single photon having a frequency corresponding to the optical transition of |0_{A(B)}> is demultiplexed by the beam splitter and concentrated on the two quantum modules respectively. The reflected wave from the quantum module is again interfered by the beam splitter, and single photon detection is performed in a dark port different from the port where the single photon is incident. Once photons are detected, entanglement formation is successful, resulting in a state (|0_{A}1_{B}>−|1_{A}0_{B}>)/√2. In this case, since the error rate is low, the distributed error-tolerant quantum computer 1 can be realized.

In addition, the remote entanglement forming module 421 may also have a light source that generates coherent light that is not a single photon. In this case, after preparing the two communication quantum bits A and B to be entangled in an overlapping state of (|0_{A(B)}>+|1_{A(B)}>)/√2, respectively, a light pulse having a frequency corresponding to an optical transition of |0_{A(B)}> is concentrated on a quantum module, and the communication quantum bits and photons emitted from the communication quantum bits are entangled. When the photon number state is represented by the basis of |0ₚₕₒₜₒₙ> and |1ₚₕₒₜₒₙ>, the state in which the communication quantum bit and the photon are entangled is (|0_{A(B)} 1ₚₕₒₜₒₙ>+1_{A(B)} 0ₚₕₒₜₒₙ>)/√2. Further, two single photons emitted from the communication quantum bits A and B are caused to interfere with each other by the beam splitter, and photons are detected at each output port. When photons are detected at only one of the output ports, entanglement formation between communication quantum bits is successful, resulting in a state of (|0_{A}1_{B}>±e^{-iϕ}|1_{A}0_{B}>)/√2. ϕ is a phase added by an optical path length. In practice, since there is a photon loss, even when only one photon is detected, there is a possibility that two photons have come to the output port. Therefore, it is preferable to apply a π pulse to each of the two communication quantum bits to invert the state, concentrate the light pulse on the quantum module again, and cause the beam splitter to interfere the single photon emission to improve an equal error rate at which photons are detected at each output port. As a result, a single photon source is unnecessary, which facilitates mounting.

In addition, the remote entanglement forming module 421 may also have either a single photon source or a single photon detector. One of the two quantum computers 2 and 10 has a single photon source and the other has a single photon detector, such that entanglement can also be formed between the communication quantum bits of different quantum computers.

### [Configuration of High-Frequency Magnetic Field Application Module According to First Embodiment]

FIG. 18 is an enlarged view of the high-frequency magnetic field application module. As illustrated in FIG. 18, the high-frequency magnetic field application module 428 includes a high-frequency oscillator that generates a high-frequency pulse and a high-frequency waveguide 4281 that transmits the high-frequency pulse. The high-frequency oscillator generates a high-frequency pulse having a frequency of 100 kHz to 100 GHz. The high-frequency waveguide 4281 includes, for example, a high-frequency waveguide such as a coplanar waveguide, a strip line, or a microstrip line, and performs one quantum bit gate operation to change an overlapping state of communication quantum bits or data quantum bits.

Specifically, a high-frequency pulse oscillated from a high-frequency oscillator is transmitted to the high-frequency waveguide 4281 to generate a high-frequency magnetic field pulse at the position of the quantum module 31, thereby operating the quantum bit. When the frequency of the high-frequency pulse and the transition frequency (100 kHz to 100 GHz) of the two levels corresponding to the quantum bit coincide with each other, the overlapping state can be coherently changed by the Rabi-oscillation. Although it is desirable to perform a selective operation in which only the quantum bits to be operated are operated and other quantum bits are not affected, that is, an operation without crosstalk, the crosstalk cannot be eliminated in practice because the magnetic field spreads spatially. Therefore, in order to selectively perform the operation, the crosstalk can be minimized by changing the resonance frequency between the quantum bit to be operated and the quantum bit not to be operated. In order to change the resonance frequency, for example, the magnetization pattern of the quantum module array may be adjusted by light. Note that a coil that generates a static magnetic field may be disposed in the control module 4 to spatially change the magnetic field. A plurality of frequencies may be multiplexed as the frequency of the high-frequency magnetic field. In addition, the high frequency may be appropriately read as a microwave or a radio wave. In general, a microwave is used when an electron spin is operated, and a radio wave is used when a nuclear spin is operated. In addition, the high-frequency oscillator may be provided in the control circuit 44. In that case, an area of the high-frequency magnetic field application module 428 can be reduced, and the operation can be speeded up.

### [Configuration of Light Irradiation Module According to First Embodiment]

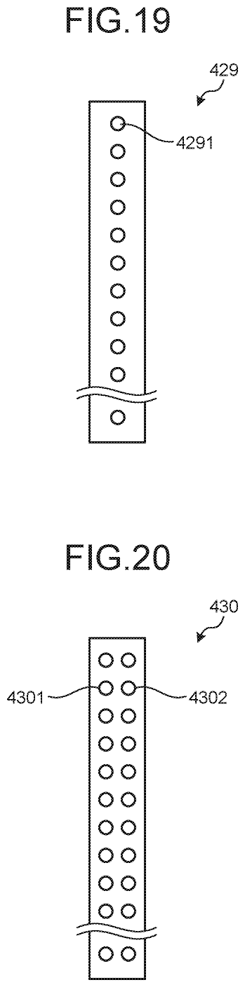

FIG. 19 is an enlarged view of the light irradiation module. As illustrated in FIG. 19, the light irradiation module 429 irradiates the magnetic body of the magnetic multilayer film 34 with light to change the magnetization, and selects the quantum module 31 that operates the quantum state. The light irradiation module 429 includes a light source that generates an electromagnetic wave, an optical waveguide that transmits the electromagnetic wave, and a concentrator that irradiates the selected quantum module with the electromagnetic wave.

The light irradiation module 429 is used for a plurality of purposes, and the wavelength, the output, the pulse width, and the number of output ports are different depending on the purpose, and it is preferable to use optimum ones. In addition, since the light irradiation module 429 emits light only from a necessary output port, a light source such as a light emitting diode or a laser diode may be provided for each output port, and the transmittance of light uniformly supplied through the optical waveguide may be switched by an optical modulator.

The light irradiation module 429 switches the magnetization pattern of the quantum module array 3 by irradiating the quantum module array 3 with light. The light irradiation module 429 changes the static magnetic field at the position of the quantum module 31 to be operated. The wavelength of the light irradiated by the light irradiation module 429 is preferably a wavelength that does not interfere with an electronic system of the quantum module 31.

In addition, the light irradiation module 429 can also perform an operation (one quantum bit gate) of changing the overlapping state of the communication quantum bit and the data quantum bit. As a result, the light irradiation module 429 can perform an operation of changing the overlapping state of the communication quantum bit and the data quantum bit instead of the high-frequency magnetic field application module 428. By using light having excellent condensing characteristics for the operation of changing the overlapping state of the communication quantum bit and the data quantum bit, it is not necessary to change the resonance frequency for each quantum bit like a microwave, and the configuration and procedure can be simplified. Note that the transition frequency of the quantum bit and the frequency of the coherent light (>100 THz) are greatly different in the band, but the state of the quantum bit can be coherently controlled by selecting an appropriate electron orbit, polarization, wavelength, pulse width, and output. For example, in a case where two levels of mₛ=+1 and mₛ=−1 in the basis state of the NV center are used for the quantum bit, the quantum bit can be controlled by a method such as Rabi-oscillation, an induced Raman adiabatic process (STIRAP: Stimulated Raman Adiabatic Passage), or a holonomic gate by using a coherent light pulse.

In addition, the light irradiation module 429 irradiates the quantum module 31 with a coherent light pulse of an appropriate frequency in order to initialize the states of the communication quantum bit and the data quantum bit.

### [Configuration of Reflectance Measurement Module According to First Embodiment]

FIG. 20 is an enlarged view of the reflectance measurement module. As illustrated in FIG. 20, the reflectance measurement module 430 includes a single photon source 4301 that generates a single photon, a single photon detector 4302 that detects the single photon reflected from the quantum module and measures the reflectance, an optical waveguide that transmits the single photon, and a concentrator that concentrates the single photon on the quantum module.

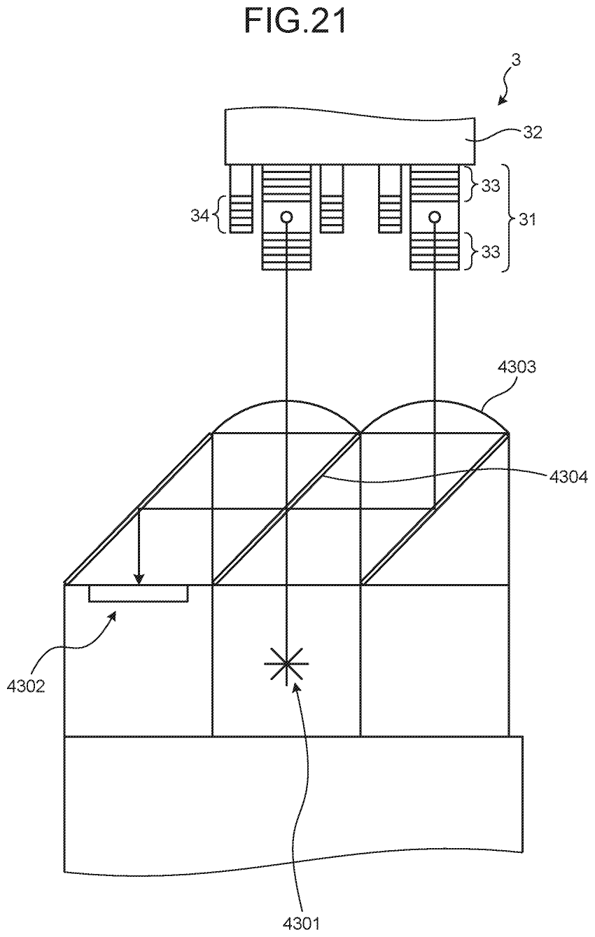

FIG. 21 is a cross-sectional view of the remote entanglement forming module. As illustrated in FIG. 21, when the quantum module array 3 rotates, the single photon source 4301 irradiates the quantum module 31 located directly above the single photon source 4301 with a single photon at a predetermined timing. Further, the single photon detector 4302 measures the reflectance of the reflected light of the quantum module 31 irradiated with the single photon by the single photon source 4301 and received via the concentrator 4303 and the beam splitter 4304.

The reflectance measurement module 430 concentrates the single photon on the quantum module 31 and detects the single photon reflected from the quantum module 31, thereby measuring the state of the four-level system. For example, in a case where the frequency ω of the single photon is set to the optical transition frequency ω₀ of the electron in the state |0>, there is a high probability of |0> when the photon is detected, and there is a high probability of |1> when the photon is not detected. In practice, there is a photon loss, such that even when no photon is detected, it may be |0> instead of |1>. Therefore, by inverting |0> and |1> by the microwave π pulse, it is confirmed that the presence or absence of photons is inverted, and thus, it is possible to perform measurement a plurality of times and enhance the fidelity of measurement. In the following examples, reflectance measurement is performed ten times, and microwave application is performed nine times, alternately and repeatedly. In a case of using a nuclear spin for a data quantum bit, when the data quantum bit is measured, the communication quantum bit and the data quantum bit are entangled by a two-quantum bit gate by ultrafine interaction or the like, and then the communication quantum bit is measured.

Note that the reflectance measurement module 430 may have a light source that generates coherent light that is not a single photon, and may be configured to measure the reflectance of the quantum module 31. For example, the state of the communication quantum bit is measured with a high reflectance corresponding to |1> and a low reflectance corresponding to |0>. As in the case of the single photon, the fidelity can be enhanced by alternately and repeatedly performing the measurement across the microwave π pulse. As a result, a single photon source is unnecessary, which facilitates mounting.

In addition, in the first functional block 41 to the third functional block 43, a blank module having no configuration can be used for the application of a radio wave pulse, the adjustment of the timing of the operation of applying the radio wave pulse or the like, and a standby.

### [Configuration of Third Functional Block According to First Embodiment]

As illustrated in FIG. 14, the third functional block 43 executes initialization and the like of the electron spin.

### [Configuration of Control Circuit According to First Embodiment]

The control circuit 44 converts a quantum circuit (program) that performs calculation into a pattern of a measurement basis of a data quantum bit. Specifically, a measurement result of the quantum module 31 is received from each operation module of the control module 4, a position and a type of an error are estimated based on the result, and a measurement basis for executing error correction is calculated. In addition, the control circuit 44 manages the states of the communication quantum bits and the data quantum bits, calculates the operation timing of each operation module of the control module 4, and controls the operation of each operation module.

The control circuit 44 controls driving of the distributed error-tolerant quantum computer 1. The control circuit 44 is realized by, for example, a central processing unit (CPU), a micro processor unit (MPU), or the like executing a program stored in a storage apparatus using a random access memory (UM) or the like as a work area. In addition, the control circuit 44 may be realized by, for example, an integrated circuit such as an application specific integrated circuit (ASIC) and a field programmable gate array (FPGA). In addition, the control circuit 44 may be an apparatus integrated with the control module 4 or may be a separate apparatus.

### [Configuration of Optical Converter Array According to First Embodiment]

The optical converter array 45 is realized by arranging spot size converters and grating couplers in an array. The optical converter array 45 combines the optical fiber array and the optical integrated circuit, and couples control modules of different quantum computers (the quantum computer 2 and the quantum computer 10) by the optical fiber 9.

### [Configuration of Communication Interface According to First Embodiment]

When the control module 4 is divided into a plurality of parts, the communication interface 46 transmits and receives a signal by an electric signal or an optical signal. The communication interface 46 transmits and receives signals to and from the divided control modules 4 when processing with a high calculation load such as error position estimation in error correction is executed by a classical computer (a part of the divided control modules 4) in the related art installed at a room temperature.

### [Configuration of Driving Apparatus According to First Embodiment]

The driving apparatus 5 rotates at least one of the quantum module array 3 and the control module 4. The driving apparatus 5 includes a shaft that rotates at least one of the quantum module array 3 and the control module 4, and a motor that rotates the shaft. The shaft is fixed to the quantum module array 3 or the control module 4, and when the motor rotates, the shaft and the quantum module array 3 or the control module 4 are integrally rotationally driven. Note that the shaft and the quantum module array 3 or the control module 4 are not fixed, and the quantum module array 3 or the control module 4 may be rotated in a floating state by a force such as a magnetic force.

### [Configuration of Magnetic Field Application Apparatus According to First Embodiment]

The magnetic field application apparatus 6 includes a magnetic field application apparatus that applies a static magnetic field to the entire quantum module array. The magnetic field application apparatus 6 applies a static magnetic field to the entire quantum module array 3 by a superconducting coil or the like.

### [Configuration of Oscillating Magnetic Field Generating Apparatus According to First Embodiment]

The oscillating magnetic field generating apparatus 7 includes a high-frequency oscillator that generates a high-frequency signal having a frequency of 100 kHz to 100 GHz, and a coil that generates a uniform alternating magnetic field in at least a part of the quantum module array 3. Further, the oscillating magnetic field generating apparatus 7 performs an operation of changing the overlapping state by applying an oscillating magnetic field equal to the resonance frequency to the quantum bit. When the quantum bits to be operated are selected, the magnetization pattern of the quantum module array 3 may be adjusted by the light irradiation module 429. In addition, the oscillating magnetic field generating apparatus 7 may also have the function of the magnetic field application apparatus 6 described above.

In addition, in the oscillating magnetic field generating apparatus 7, the coil may be formed in the control module 4. Accordingly, the apparatus can be downsized. In addition, the crosstalk can be reduced by locally generating the oscillating magnetic field. Furthermore, although the shape of the coil may be arbitrary shape, when a Helmholtz coil that generates an oscillating magnetic field oscillating in a vertical direction with respect to the magnetic field generated by the magnetic field application apparatus 6 is used, a uniform oscillating magnetic field can be generated in the quantum module array 3. In addition, when two coils orthogonal to each other are used as the oscillating magnetic field generating apparatus 7, a rotating magnetic field can be generated, and an error rate can be improved.

In addition, the radio wave oscillator is independently installed outside the control module 4, and receives a signal from the control module 4. As a result, heat generation of the control module 4 can be suppressed. In addition, the radio wave oscillator may be disposed in the control module 4. In this case, communication between the control module 4 and the radio wave oscillator becomes unnecessary. Furthermore, the oscillating magnetic field generating apparatus 7 may be used by multiplexing a plurality of frequencies. In this case, since different operations can be simultaneously executed for each group of quantum bits, the processing can be speeded up.

### [Configuration of Refrigerator According to First Embodiment]

The refrigerator 8 freezes the quantum module array 3 and at least a part of the control module 4. However, the refrigerator 8 may cool only the quantum module array 3, and the control module 4 may have a higher temperature such as room temperature. Since it is not necessary that all the configurations of the control module 4 are at a low temperature, it is possible to reduce the power consumption and downsize the apparatus by setting a part thereof to a room temperature.

In addition, a space between the quantum module array 3 and the control module 4 is, for example, evacuated, but can be constituted by a gas such as helium, a liquid such as superfluid helium, a solid such as a glass plate, or a combination thereof. As a result, the power consumption can be reduced and the error rate can be reduced. In addition, a tracking mechanism may be provided in the control module 4 in order to offset the oscillation of the quantum module array 3 accompanied by the rotation and to keep the distance between the quantum module array 3 and the control module 4 constant.

### [Configuration of Optical Fiber According to First Embodiment]

The optical fiber 9 couples the quantum computer 2 and the quantum computer 10 to each other and operates them as the distributed error-tolerant quantum computer 1.

### Effects

The apparatus can be downsized.

### [Example of Distributed Error-Tolerant Quantum Computer According to First Embodiment]

In the quantum module array 3, the substrate 32 includes a disk-shaped silicon substrate having a diameter of 30 mm and a thickness of 1 mm, and forms a dielectric multilayer film mirror of SiO₂/TiO₂ as the dielectric multilayer film 33. A diamond (111) single crystal thin film having a thickness of 1 μm is bonded thereon, and a dielectric multilayer film mirror of SiO₂/TiO₂ is further formed thereon as the dielectric multilayer film 33. As a result, a Fabry-Perot type vertical optical resonator is formed.

In the diamond, nitrogen-vacancy (NV) centers, which are point defects, are formed by controlling isotopes, orientation, and positions. N is all ¹⁵N, and an NV axis connecting N and V is all in a [111] direction. When the dielectric multilayer film 33 is designed such that the cooperativity of the combining system between the dielectric multilayer film 33 and the NV center becomes 20, the reflectance in a case where the state of electrons of the NV center is |0> becomes 95%.

The position forming the NV center corresponds to a position obtained by developing an arrangement (see FIG. 5) in which two layers of a prime plane and a dual plane of Raussendorf lattice, which is a quantum entanglement network structure between the quantum bits (cluster state) used for mounting of a three-dimensional topological error correction code, are two-dimensionally arranged in an annular shape.

Assuming that a minimum interval between the NV centers in the arrangement before being annularly disposed is 10 μm, the number of 80 μm×80 μm unit cells including 24 NV centers is 400 (only 12 are illustrated in FIG. 2) arranged in the direction along the circumference and 110 (only four are illustrated in FIG. 2) arranged in the direction along a radius, and the number is 1.06 million in the entire arrangement. Note that since two levels of the ¹⁵N nuclear spin at each NV center are used as data quantum bits, the total is 1.06 million quantum bits.

When this unit cell is developed in an annular shape, as illustrated in FIG. 2, the interval between the quantum modules 31 in a circumferential direction increases toward an outside in a radial direction. On the other hand, the interval between the quantum modules 31 along the radial direction is constant. Therefore, a distance L31 corresponding to the size of the 110 unit cells is 8.8 mm, a distance L32 corresponding to an inner diameter of an annulus in which the arrangement of NV centers is formed is 10.2 mm, and a distance L33 corresponding to an outer diameter of the annulus is 27.8 mm. Note that in this example, in order to simplify the description, an example will be described in which the interval between the quantum modules 31 in the circumferential direction is increased toward the outside in the radial direction, but the interval between the quantum modules 31 in the circumferential direction may be disposed to gradually change such that a surface density becomes constant regardless of the position in the radial direction. In this case, since the surface density of the quantum module 31 is constant, mounting is facilitated.

In the quantum module 31, two levels (hereinafter, also described as electron spin) of the basis state of the electron of the NV center are used as the communication quantum bits. The spin magnetic quantum numbers mₛ=0 and mₛ=+1 correspond to the states |0> and |1>, respectively. When the state of the electron spin is |1>, the electron spin and the nuclear spin acquire a relative phase by ultrafine interaction. Therefore, when the electron spin is brought into an overlapping state of |+>=(|0>+|1>)/√2, the electron spin moves back and forth between an unentangled state |+>|n+> and a maximum entangled state (|0>|n+>+|1>|n>)/√2 at a cycle of 330 ns. The state of the nuclear spin is |n_{±}>=(|↑>±|↓)/√2. Such ultrafine interaction functions as a CZ gate (control phase gate) between the electron spin and the nuclear spin that becomes (|0>|n_{±}>+|1>|n₋>)/√2 in 165 ns from |+>|n₊>, and can be utilized in measuring and initializing the nuclear spin state and transferring the entanglement formed between the electron spins between the nuclear spins. In addition, the ultrafine interaction can also be used to shorten the time required for the rotation of the nuclear spin by radio waves.

Since radio waves and microwaves are used for the operation of the nuclear spin and the electron spin of the NV center, the magnetic multilayer film 34 having a diameter of 2 μm was formed at six positions of 3 μm from each NV center such that the NV center to be operated can be selected. As the magnetic multilayer film 34, for example, an exchange-combined multilayer film obtained by stacking four layers (memory layer/recording layer/switch layer/initialization layer) of perpendicular magnetic anisotropic ferromagnetic thin films having different Curie temperatures can be used. When the material is selected such that the Curie temperature satisfies T_{c4}>T_{c2}>T_{c1}>T_{c3}, the magnetization of the memory layer can be inverted according to the intensity of the light pulse. The intensity and the pulse width of the light pulse are set such that the temperature T_{M} of the magnetic multilayer film is T_{c2}>T_{M}>T_{c1} in the case of weak light and T_{c4}>T_{M}>T_{c2} in the case of strong light. As the exchange-combined multilayer film, for example, four layers of TbFeCo (80 nm), GdByFeCo (150 nm), TbFe (20 nm), and TbCo (40 nm) used in a magneto-optical disk (MO) can be used respectively. Note that the Curie temperature may be lowered by using an alloy of these material systems and a nonmagnetic metal such as copper or aluminum.

It is considered that when the magnetic body is heated by light irradiation, the NV center located in the vicinity thereof is also heated, and the error rate increases, but the influence is slight. First, the temperature attenuates in a Gaussian function shape as the distance from the light irradiation position increases, and also attenuates quickly in terms of time by stopping the light irradiation. Furthermore, it is known that a spectral linewidth and a coherence time of the NV center are hardly affected even when the temperature rises by several K. Therefore, an increase in the error rate due to heating of the NV center is slight.

The quantum module array 3 and a part of the control module 4 are cooled to a temperature of 2K by the refrigerator 8. The quantum module array 3 and the control module 4 are disposed to face each other at a distance of 5 μm. Furthermore, the periphery of the quantum module array 3 is replaced with helium and then decompressed. The quantum module array 3 is fixed to a shaft of the driving apparatus 5 and rotated at 56,818 rpm. The number of rotations is determined based on the ultrafine interaction period of 330 ns and the interval of the operational modules of the control module 4. In addition, in order to solve the degeneracy of mₛ=±1 of the basis state of the NV center, an external magnetic field is applied by the magnetic field application apparatus 6 in parallel with the rotation axis of the quantum module array 3. The magnetic field application apparatus 6 is adjusted such that the combined magnetic field of the magnetic field by the magnetic body and the external magnetic field at the NV center position becomes 20 mT as an average value of the channel MW4 and the channel MW5 described later.

The control module 4 is formed by mounting an optical integrated circuit and a control circuit (analog electronic circuit and digital circuit) on a silicon substrate of 50 mm□. A part of the control circuits that do not fit on a 50 mm□ silicon substrate may be installed at a room temperature and electrically coupled. Furthermore, as the first functional block 41 to the third functional block 43, five types of operation modules (remote entanglement forming modules 421 to 427, high-frequency magnetic field application module 428, light irradiation module 429, reflectance measurement module 430, and blank module) are disposed in an annular shape, and the rotating NV centers are sequentially operated, thereby executing the error-tolerant quantum calculation.

Since the arrangement of the NV centers is formed in an annular shape having an inner diameter of 10.2 mm and an outer diameter of 27.8 mm, each operation module of the control module 4 is formed in an annular shape to be located immediately above the NV centers at a predetermined timing. In order to simplify the description, the length of each operation module of the control module 4 indicates a value based on 32 mm (10.2 π mm), which is the inner circumference of the annulus in which the NV centers are arranged, but actually, since the interval between the quantum modules 31 increases outward, each operation module has an annular fan shape close to a trapezoid. In addition, each operation module of the control module 4 is coupled to the optical circuit and the electronic circuit outside the annulus in which the NV centers are arranged.

In the NV center, when the electron spin becomes |1>, the phase is accumulated in the nuclear spin by the ultrafine interaction, and thus, a mechanism for managing the phase and not accumulating an error in the nuclear spin is required. Since the phase due to this ultrafine interaction can be corrected before the measurement when it can be predicted, it is desirable that all the quantum bits receive the same operation as much as possible and acquire the same phase. In addition, when a time interval of the operation is 330 ns, since the operation can be performed at the timing when the entanglement between the electron and the nuclear spin is resolved, even when the entanglement formation between the electron spins or the measurement fails, the influence on the nuclear spin can be minimized. Since the time interval of 330 ns corresponds to 10 μm in terms of the distance of the inner circumference, the length of the module is designed to be a multiple of 10 μm.

The arrangement of each operation module of the control module 4 can be designed for each of the first functional block 41 to the third functional block 43. As described with reference to FIG. 14, the first functional block 41 executes an operation of performing measurement and initialization of nuclear spins, the second functional block 42 executes an operation of forming entanglement between nuclear spins, and the third functional block 43 executes other operations such as initialization of electronic spins.

First, in order to execute the quantum calculation, after the states of the electron spin and the nuclear spin are initialized to |0> and |n+> by the first functional block 41, the calculation is advanced while alternately repeating the entanglement formation between the nuclear spins of different quantum modules by the second functional block 42 and the measurement and initialization of the nuclear spin by the first functional block 41.

The quantum module array 3 is driven by the driving apparatus 5 to rotate once every 1.056 ms. This single rotation can be converted into 947 Hz in terms of frequency and 56,818 rpm in terms of the number of rotations per minute. Further, during one rotation, all the NV center rows pass over the first functional block 41 to the third functional block 43 in order, and measurement of the nuclear spins and entanglement formation between the nuclear spins are executed.

The state of any one of the operation steps 1 to 6 described with reference to FIGS. 7 to 12 is formed by using the remote entanglement forming modules 421 to 426 every one rotation, the quantum module 311 to be subjected to the nuclear spin measurement and the non-operation quantum module 312 are switched, and the nuclear spins are sequentially measured by the functional block 1 to measure all the nuclear spins every six rotations.

However, any one operation step of the operation steps 1 to 6 may be executed in a plurality of rotations to further increase resistance to the photon loss and errors. By increasing the number of rotations per operation step, errors can be reduced due to entanglement formation between the nuclear spins. The entanglement formation between the electron spins via photons, which is necessary for the entanglement formation between the nuclear spins, greatly reduces a success probability when there is a photon loss in the middle. Assuming that a probability at which photons emitted from the single photon source are actually detected in a state to be detected by a single photon detector is η, a probability of successful entanglement formation between electrons can be represented by p=ηRᵢ/8. Rᵢ is the reflectance of the optical resonator when the state of the electron spin is |i>. As an example, when η=78% and Rᵢ=0.98, p=9.56%. In order to finally achieve a probability P of successful entanglement formation in a cluster state, the number of trials s required for entanglement formation between electron spins is given by s=log (1−P)/log (1−p). In a case where the probability p=9.56% and the probability P=90%, the number of trials s≈23 can be calculated, and it is found that it is necessary to repeat 23 times. When the probability P decreases, an error tolerance decreases in the error-tolerant quantum calculation, but since the quantum bit pair failed in entanglement formation can be specified, it is known that the error-tolerant quantum calculation can be performed even with the probability P=90% by reflecting the information in the calculation of the measurement basis (see Non Patent Literature 2). In order to further increase the probability P of successful entanglement formation, the number of trials may be increased by increasing the number of rotations per operation step. For example, when the number of trials is increased to 46 by making two rotations per operation step, P=99%.

Here, before proceeding to the description of the first functional block 41 to the third functional block 43, channel assignment will be described. Since both the radio wave for performing the rotation operation of the nuclear spin and the microwave for performing the rotation operation of the electronic spin spread spatially, crosstalk to which an unintended operation is applied occurs due to the influence on the quantum bits other than the operation target. In particular, since the radio wave is uniformly applied to the entire quantum module array 3, the resonating quantum bits are simultaneously operated. Therefore, by setting different channels (resonance frequencies) for each quantum bit, it is possible to selectively perform the operation. In addition, the high-frequency magnetic field application module 428 has the high-frequency waveguide 4281 such that microwaves can be locally emitted, but an interval between adjacent quantum bits is at least 10 μm, and crosstalk cannot be reduced unless different channels are set in the adjacent quantum bits. Therefore, the magnetic field at the position of the NV center is set in multiple stages by using the magnetization state by the magnetic multilayer film 34 including the six magnetic bodies (see FIG. 6) surrounding the NV center. Since the amounts of change in the resonance frequency of the nuclear spin and the electron spin with respect to the magnetic field are 4.32 MHz/T and 28 GHz/T, respectively, for example, when the magnetic field is different by 3.6 mT between the respective channels, the resonance frequency of the nuclear spin increases or decreases at intervals of |5 kHz and the resonance frequency of the electron spin increases or decreases at intervals of |00 MHz. Since the magnitude of the magnetic field necessary for detuning is different between the nuclear spin and the electron spin, in this example, the resonance frequency of each of the nuclear spin and the electron spin is set by using three magnetic bodies 341 and three magnetic bodies 342 of two types having different amounts of change in magnetization.

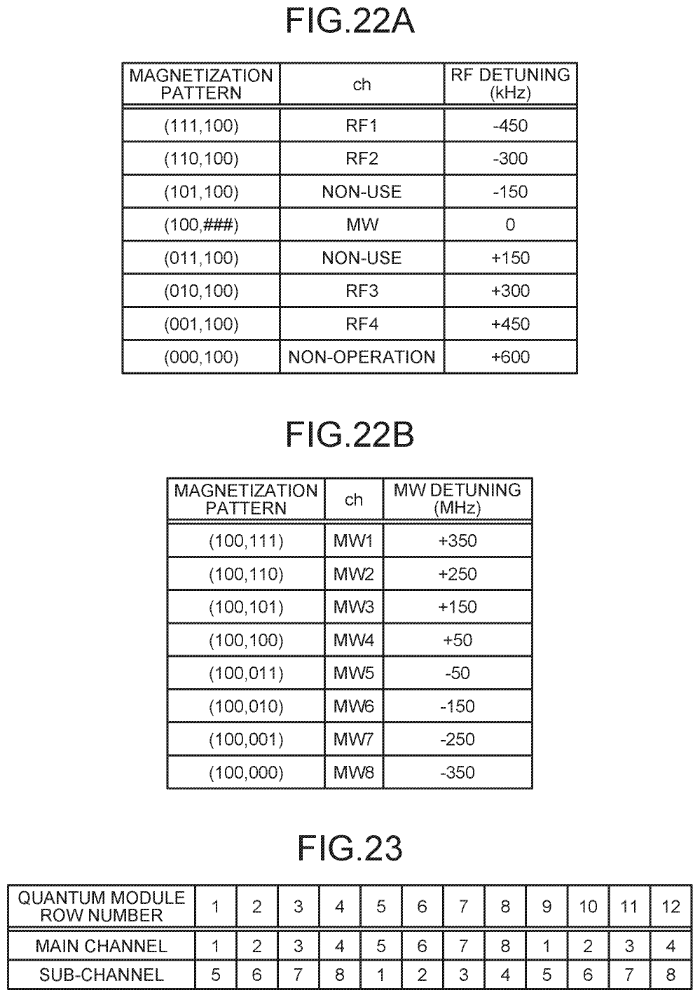

FIGS. 22A and 22B are diagrams illustrating channel assignment of radio waves and microwaves. As illustrated in FIGS. 22A and 22B, the magnetization pattern represents six magnetization states in binary numbers. Reference frequencies of RF (radio wave) and MW (microwave) are 3.12 MHz and 3.43 GHz, respectively. The detuning of the resonance frequency (the frequency of the microwave) of the electron spin affects the reflectance of the optical resonator, but the reflectance does not greatly decrease when it is about ±300 MHz. On the other hand, by optimizing the waveform of the input pulse, the total of the error rates due to the plurality of times of crosstalk accumulated between the initialization and the measurement of the nuclear spin is 0.05% in the microwave and 0.06% in the radio wave, which is sufficiently smaller than 1% required for the error-tolerant quantum calculation, and it is found that the error rate due to crosstalk is effectively reduced. When a π pulse of the microwave is 50 ns, the error rate due to crosstalk to the adjacent quantum bits detuned at 100 MHz is 2.5×10⁻³, and when a π/2 pulse of the radio wave is 25 us, the error rate due to crosstalk at the time of detuning at 150 kHz is 5×10⁻⁶.

In addition, in the case of radio waves, in order to perform batch processing, two channels of a main channel and a sub-channel are assigned to each of two regions (blank modules as operation modules) to be operated by radio waves, and the regions are alternately used. In addition, when the operation is performed with microwaves, it is necessary to set two types of main channels and sub-channels, and it is preferable to minimize crosstalk between these channels. FIG. 23 is a diagram illustrating channel assignment of microwaves of a quantum module row. As illustrated in FIG. 23, channels of adjacent quantum module 31 rows (in the circumferential direction) are assigned in eight quantum bit cycles.

As described above, by changing the magnetization of the magnetic bodies 341 and 342 located near the quantum bits by light and selecting the quantum bits to be operated by radio waves or microwaves, it is possible to mount the quantum bits at high density while suppressing crosstalk among many quantum bits. On the other hand, the detuning of the resonance frequency also affects the ultrafine interaction, thus slightly changing the cycle of entanglement between the electron spin and the nuclear spin from 330 ns. Therefore, when the operation is continued at a cycle of 330 ns, the operation timing gradually deviates, which causes an error. Therefore, the positive and negative of the detuning frequency are inverted for each functional block, and the channel is set such that the entanglement cycle does not greatly deviate from 330 ns.

|n the first functional block 41, only the quantum module to be subjected to the measurement and initialization of the nuclear spin is selectively operated. First, only the quantum module to be measured is set to the MW channel by the light irradiation module 429, and an unintended phase accumulated in the nuclear spin in the calculation process is corrected. Next, only the quantum module 31 for measuring the X basis is set to the MW channel or the RF channel, and measurement of the X basis and initialization of the electron spin and the nuclear spin are performed. Subsequently, only the quantum module 31 for measuring the Z basis is set to the MW channel or the RF channel, and measurement of the Z basis and initialization of the electron spin and the nuclear spin are performed. Finally, all the quantum modules 31 for which the measurement has been completed are set to the non-operation channels.

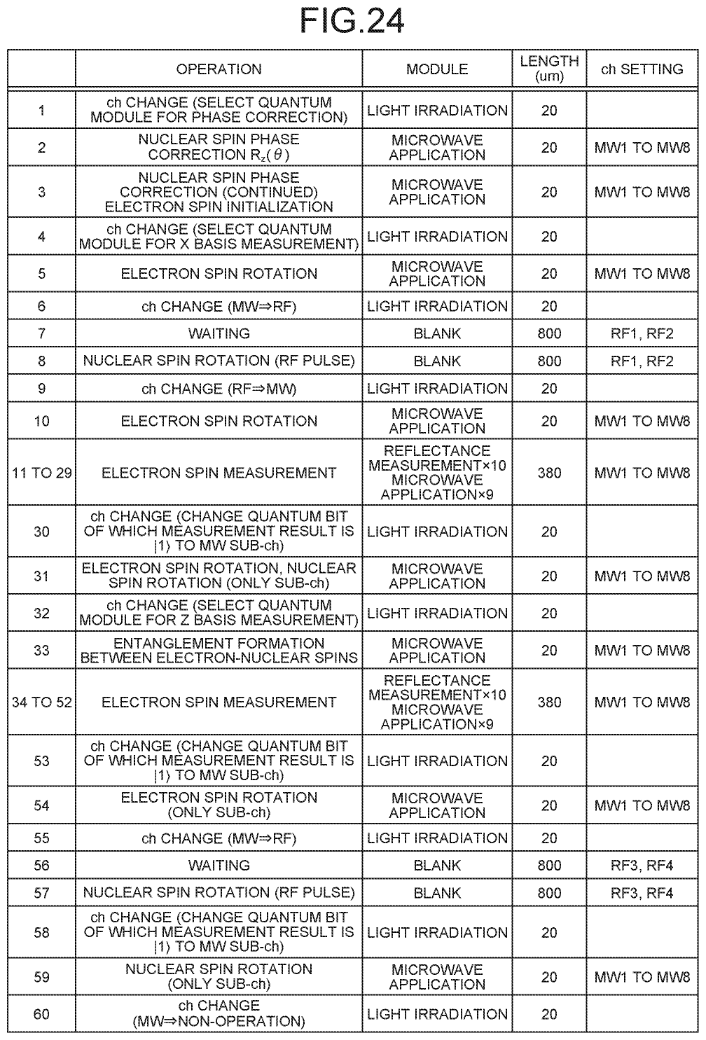

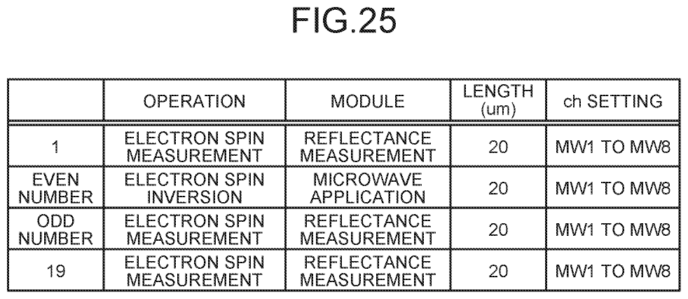

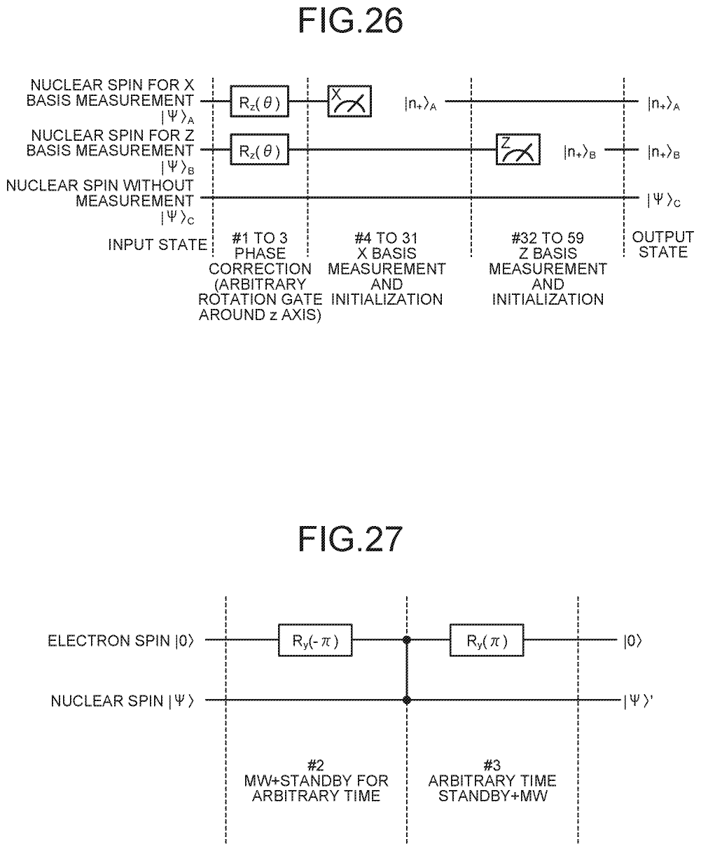

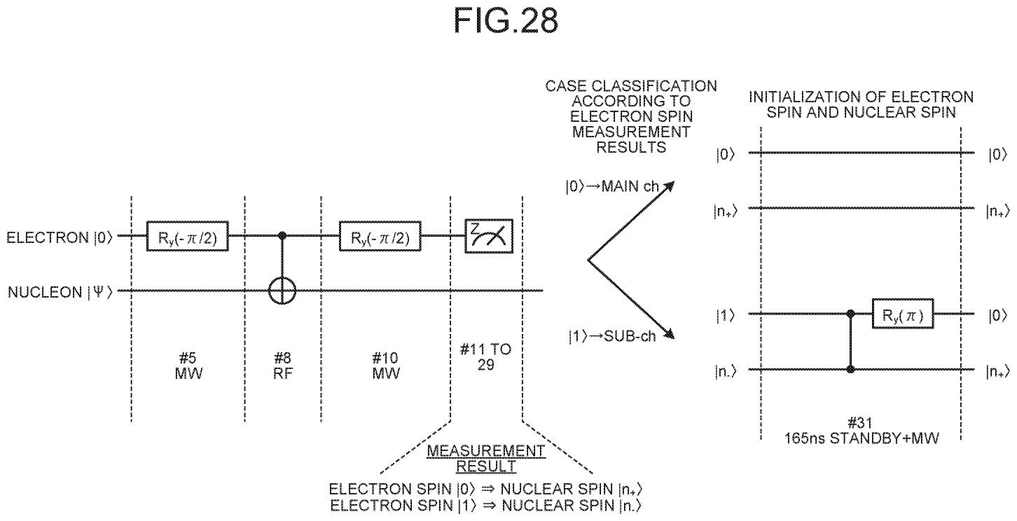

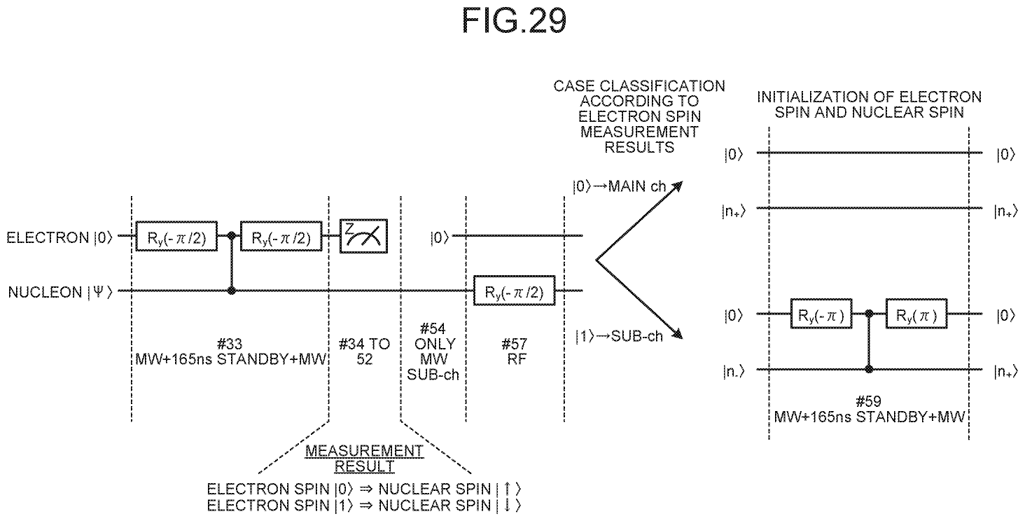

FIG. 24 is a diagram illustrating an operation in the first functional block. FIG. 25 is a diagram illustrating measurement of an electronic spin state corresponding to operation steps 11 to 29 and 34 to 52 in FIG. 24. FIGS. 26 to 29 are diagrams schematically illustrating operations in the first functional block. A series of operations in the first functional block 41 are executed by sequentially passing each NV center of the rotating quantum module array 3 over each operation module of the control module 4, and sequentially performing electron spin rotation by a microwave, nuclear spin rotation by a radio wave, and measurement of an electronic spin state. Specifically, the operation modules are arranged in the order of the numbers illustrated in FIG. 24, and the operations illustrated in FIG. 24 are sequentially executed. Since the RF pulse of the nuclear spin rotation is as long as 25 us, batch processing is executed on the NV centers of the plurality of the quantum module 31 rows. The RF main channel and the RF sub-channel are alternately set for every 80 rows of the quantum module 31 rows, and after the channel setting of 80 rows is completed, an RF pulse is applied to the entire quantum module 31 at the frequency of each RF channel. On the other hand, since the microwaves sequentially operate for each of the quantum module 31 rows, the channel is set in eight row cycles and in units of the quantum module 31 rows. As described above, in order to avoid an unintended operation (crosstalk), the processing is performed while frequently changing the quantum bit channel setting by irradiating the magnetic multilayer film 34 with light by the light irradiation module 429.

For phase correction, the ultrafine interaction between the electron spin and the nuclear spin is used. When the electron spin is set to |1>, the nuclear spin rotates about the Z axis. The rotation speed at this time depends on the resonance frequency of the nuclear spin, but is about 330 ns per 2 π. Microwaves are applied by the second and third (see FIG. 24, in the following description, the number in the leftmost row in FIG. 24 is described as “th”) operation modules of the first functional block 41 such that the electronic spin becomes |1> for a time corresponding to the rotation angle to be corrected. Note that in this example, all the rotation axes of the microwave rotation pulses to be applied are unified around the y axis, but in practice, the rotation axis of the microwave rotation pulse may be any rotation axis as long as the same result is obtained. When a R_{y} (θ) pulse is applied with the rotation angle as θ, the quantum bits are in a state in which a 2×2 matrix indicated in the following Formula (2) acts from the left.

$${R}_{y} ( θ ) = ( \begin{matrix}cos \frac{θ}{2} & - sin \frac{θ}{2} \\ sin \frac{θ}{2} & cos \frac{θ}{2}\end{matrix} ) \qquad ( 2 )$$

In the X basis measurement of the nuclear spin, after applying a microwave R_{y} (−π/2) pulse by the fifth operation module of the first functional block 41, a CNOT pulse of the radio wave is applied from the oscillating magnetic field generating apparatus 7 while the quantum module 31 stays in the eighth blank module of the first functional block 41. Thereafter, the microwave R_{y} (−π/2) pulse is applied again by the tenth operation module of the first functional block 41, and the state of the electron spin is measured in the Z basis by the 11th to 29th operation modules of the first functional block 41. Since the states of the electron spin and the nuclear spin are entangled, it is found that the nuclear spin is |n+> when the electron spin is |0>, and |n> when |1>. Since it is desired to initialize the electron spin to |0> and the nuclear spin to |n+>, in a case where the measurement result of the electron spin is |1>, the corresponding quantum module 31 is set to an MW sub-channel, a microwave R_{y} (π) pulse is applied by the 31st operation module of the first functional block 41 at the timing (when the electron spin is |1>, the nuclear spin rotates at a cycle of 330 ns) when the nuclear spin changes from |n> to |n₊>, and the electron spin is rotated from |1> to |0>. As a result, the electron spin can be initialized to |0>, and the nuclear spin can be initialized to |n₊>.

In the Z basis measurement of the nuclear spin, after applying the microwave R_{y} (−π/2) pulse twice by the 33rd operation module of the first functional block 41, the Z basis measurement of the electronic spin is performed by the 34th to 52nd operation modules of the first functional block 41. By waiting for 165 ns between the two microwave pulses in the 33rd operation module of the first functional block 41, a control phase gate (CZ gate) is performed between the electron spin and the nuclear spin. It is found that, when the measurement result of the electron spin is |0>, the nuclear spin is |↑>, and when the measurement result of the electron spin is |1>, the nuclear spin is |↓>. Only the quantum module 31 of which the measurement result of the electron spin is |1> is set as the microwave sub-channel, and the microwave R_{y} (7) pulse is applied only to the sub-channel by the 54th operation module of the first functional block 41, such that all the electron spins can be set to |0>. Thereafter, all the channels are set to RF3 or RF4 channels, and when a radio wave R_{y} (−π/2) pulse is applied from the oscillating magnetic field generating apparatus 7 by the 57th operation module of the first functional block 41 to rotate the nuclear spin, the nuclear spin |T> becomes |n+> and the nuclear spin |↓> becomes |n₋>. Again, only the quantum module 31 of which the measurement result of the electron spin is |1> is set as the microwave sub-channel, and the 59th operation module of the first functional block 41 applies a microwave R_{y} (−π) pulse to set the electron spin to |1>. Thereafter, by waiting for 165 ns, the nuclear spin is rotated from |n₋> to |n+>, and thereafter, by applying the microwave R_{y} (π) pulse to return the electron spin from |1> to |0>, the electron spin can be initialized to |0> and the nuclear spin to |n₊>.

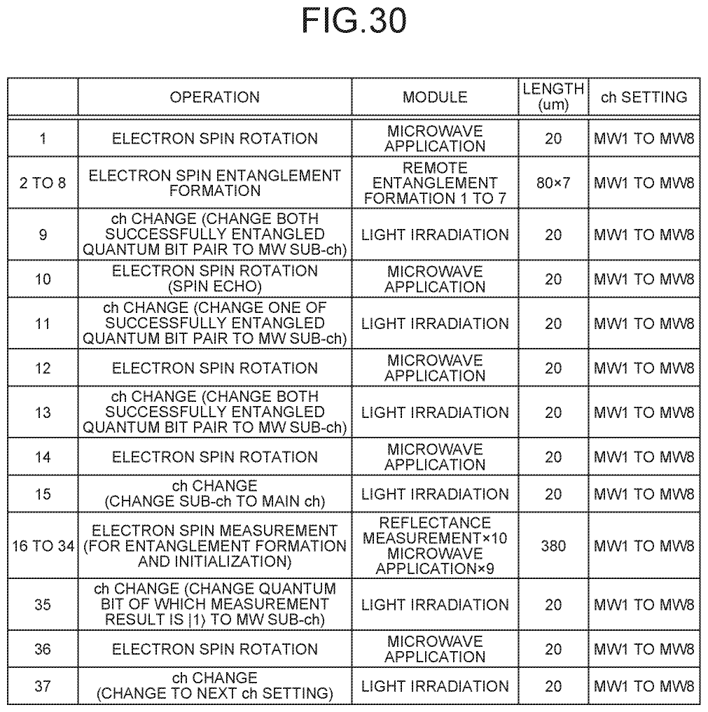

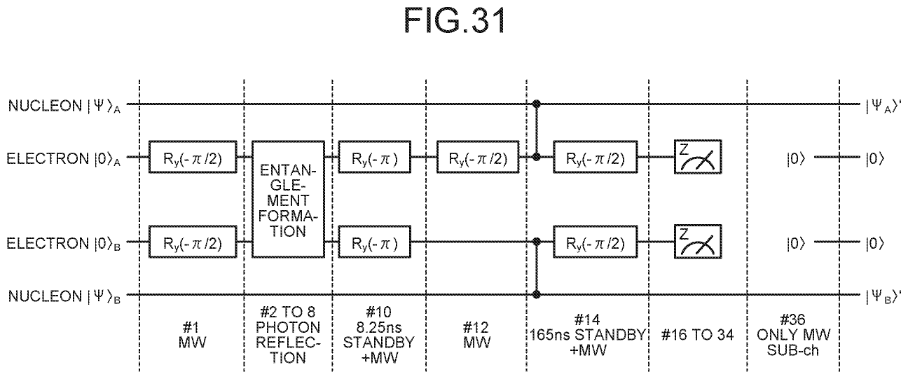

FIG. 30 is a diagram illustrating an operation in the second functional block. FIG. 31 is a diagram schematically illustrating an operation in the second functional block. In the second functional block 42, entanglement is formed between the nuclear spins. First, electron spins are entangled via photons between spatially separated NV centers. The sets of NV centers to be entangled are each different in the operation steps 1 to 6. Since it is difficult to integrate optical systems that make the irradiation position of light variable, the remote entanglement forming modules 421 to 426 having different irradiation positions are required as many as the number of operation steps. On the other hand, since all operation steps are common other than the remote entanglement forming modules 421 to 426, in the second functional block 42, a plurality of types (six types in this example) of the remote entanglement forming modules 421 to 426 are prepared, and modules corresponding to each of the operation steps 1 to 6 are used. It is found that, in the single photon detectors in the remote entanglement forming modules 421 to 426, the entanglement formation between the electron spins was successful when photons were detected.

The quantum module 31 pair successfully entangled transfers the entanglement between the electron spins to the nuclear spin. For this purpose, first, both channels of the quantum module 31 pair are changed to sub-channels, and a R_{y} (−π) pulse is applied by the tenth operation module of the second functional block 42 at the time of 82.5 ns of a 330 ns cycle. Thereafter, waiting is performed for 82.5 ns. As a result, the phase of the entanglement cycle between the electron spin and the nuclear spin is shifted by 1800 from that of the other quantum module 31, and the maximum entangled state is obtained at a time at which the electron spin and the nuclear spin of the other quantum module 31 are not entangled.

Subsequently, only one channel of the quantum module 31 pair is set as the sub-channel, and the twelfth operation module of the second functional block 42 emits the R_{y} (−π/2) pulse at the time when there is no entanglement between the electron spin and the nuclear spin, and the state of the electron spin is rotated from (|01>−|0>)/√2 to (|+1>−|−0>)/√2. Thereafter, both channels of the quantum module 31 pair are set again as the sub channels, entanglement between the electron spin and the nuclear spin is maximized, and the 14th operation module of the second functional block 42 emits the R_{y} (−π/2) pulse at the time when the state |e₁, e₂, n₁, n₂> becomes the state (|+1↑n₋>+|−1↓n₋>−|−0↑n₊>−|+0↓n₊>)/2. By returning the sub-channel to the main channel and measuring the state of the respective electron spins together with other quantum modules 31 that fail to entangle and require initialization of the electron spins, the entanglement between the electron spins is transferred between the nuclear spins, and the state of the nuclear spins becomes (|↑n₋>+|↓n₊>)/2. Depending on the measurement result of the electron spin, a Pauli error occurs in the state of the nuclear spin, but since the error can be known, it can be corrected by changing the measurement basis at the time of nuclear spin measurement.

When entanglement is formed between the nuclear spins of different quantum computers A and B, the components of the remote entanglement forming module are divided into the quantum computer A and the quantum computer B to constitute the remote entanglement forming module 427. Therefore, the components of the quantum computer A and the quantum computer B are represented by subscripts A and B, respectively. The single photons emitted from the single photon source A are demultiplexed by the beam splitter A, one of the photons is reflected by the quantum module A, and then the single photons travel to the quantum computer B through an optical fiber. The other of the photons demultiplexed by the beam splitter A directly passes through the optical fiber to the quantum computer B and is reflected by the quantum module B. Photons reflected by the different quantum modules A and B interfere with each other in the beam splitter B, and photons emitted from one of the output ports are detected by the single photon detector B. Through the optical fiber, the photon loss increases and the entanglement success probability greatly decreases between the quantum computers A and B, but the entanglement formation between the quantum computers A and B is allowed to take more time than in a single quantum computer. Assuming an 80% photon loss while moving between the quantum computers A and B, 119 trials would be required to realize an entanglement formation rate of P=90%. This is about five rotations when converted to the rotation of the quantum module array.

In addition, in order to provide a distributed error-tolerant quantum computer that forms entanglement among a plurality of quantum computers and performs error-tolerant quantum calculation, the quantum computers may be coupled by a large number of optical fibers. For example, in Non Patent Literature 1, coupling (1 fiber/qubit) is performed by using the same number of optical fibers as the number of quantum bits. In addition, in the case of mounting in an optical integrated circuit as in Non Patent Literature 2, it is necessary to perform coupling (0.02 fiber/qubit) by the same number of optical fibers as the number of quantum bits on the outer periphery of the chip. On the other hand, in this example, since a quantum bit number of one million or more can be obtained per quantum computer, optical fiber coupling is not necessary for applications in which one million quantum bits are sufficient. Even in an application requiring a larger number of quantum bits, two-quantum bit gates of logical quantum bits in each quantum computer may be formed without coupling all the quantum bits on the outer periphery of the cluster state. For this purpose, for example, entanglement may be formed between 1000 physical quantum bits. Since there are 3200 quantum bit rows in the circumferential direction, the number of quantum modules that form entanglement between quantum computers is one or less on average per quantum module row. Therefore, it is sufficient that one optical fiber is coupled for each functional block, and the number of optical fibers is 2×10⁻⁵ fiber/qubit when converted per quantum bit, and at least the number of optical fibers can be set to 1/100 as compared with the related art.

As described above, according to the quantum module array 3 according to the first embodiment, the quantum module array 3 in which the quantum modules 31 are two-dimensionally arranged in an annular shape at a high density is rotated, and each operation module of the control module 4 performs the quantum gate operation including the entanglement formation and the measurement of the quantum state of the quantum bit at the timing when the quantum module 31 approaches each of the plurality of operation modules arranged in an annular shape to execute the error-tolerant quantum calculation. As a result, compared with Non Patent Literature 1, the number of optical fibers 9 coupling the quantum computer 2 and the quantum computer 10 can be significantly reduced, and a large number of phase modulators are not required as in Non Patent Literature 2, such that the apparatus can be downsized. Furthermore, by using localized electrons in a solid having a long coherence time as the quantum module 31, the processing can be completed within the coherence time. In addition, compared to Non Patent Literature 2, since it is not necessary to switch the light path, power consumption can be reduced.

In addition, the quantum module array 3 includes the magnetic multilayer film 34, and it is possible to select quantum bits to be operated or measured by radio waves or microwaves by changing the spatial distribution of the magnetic field by light. Therefore, it is possible to mount a large number of quantum modules 31 on the quantum module array 3 while suppressing an increase in size of the quantum module array 3.

In addition, by rotating the quantum module array 3, each operation module of the control module 4 can be shared by a plurality of NV centers, and NV centers can be mounted at high density. When NV centers mounted at a high density are individually operated by radio waves or microwaves, crosstalk becomes a problem. However, this problem can also be greatly improved by rotating the quantum module array 3 to perform local static magnetic field switching by light-induced magnetization inversion. In addition, as a compensation for such an effect, in this example, it is necessary to synchronize the operation timing, and unnecessary standby time occurs. As a result, the time required per operation step increases, and an error due to random phase relaxation between the electron spin and the nuclear spin increases. However, it is known that the phase relaxation time of the electron spin at the NV center is 1 ms or more while the time from initialization of the electron spin to |+> to successful remote entanglement formation and measurement of the electron is about 20 us, and thus the error rate due to the phase relaxation of the electron spin is 0.013% and sufficiently small. Similarly, for the nuclear spin, assuming that the phase relaxation time of the nuclear spin is 10 seconds, the error rate due to the phase relaxation of 6 ms in the measurement cycle is 0.03%, which is sufficiently small. In addition, since the entanglement formation with respect to the nuclear spin is performed four times per nuclear spin, the phase relaxation of the electron spin is 0.052% in total, and when combined with the nuclear spin, 0.082% more phase relaxation errors are accumulated as compared with the related art. On the other hand, since the physical error rate required for the error-tolerant quantum calculation is 0.6% (see Non Patent Literature 2) at the entanglement formation rate P=90%, this example can provide a small error-tolerant quantum computer having a low error rate of one million quantum bits.

In addition, in the optical integrated circuit, power consumption accompanied by switching of the circuit is large, and the footprint of the switch is also large. As a result, reducing the number of switches leads to significant low power consumption, downsizing, and cost reduction. For example, in Non Patent Literature 2, nine switches are required per NV center, and nine million switches are required for one million quantum bits. In this example, by rotating the quantum module array 3, selection of a pair of NV centers to be entangled and switching between entanglement formation between electron spins and electron spin measurement are performed, such that a switch is not required, and a quantum computer with a low power consumption, downsized, and low cost can be realized.

Furthermore, the effects described in the present specification are merely examples and are not limited, and other effects may be provided.

Note that the present technique can also have the following configurations.

(1)

A quantum information processing apparatus comprising:
a quantum module array in which a plurality of quantum modules are arranged in an array;
a control module configured to perform an operation of forming entanglement between the quantum modules and control of measurement of a quantum state of the quantum modules; and a driving apparatus configured to rotate at least one of the quantum module array and the control module.
   (2)

The quantum information processing apparatus according to (1), wherein
the quantum module array includes a magnetic body disposed close to a physical system used as a quantum bit forming the quantum module, and
the control module includes a light irradiation module that irradiates the magnetic body with light to change magnetization and selects the quantum module that operates the quantum state.
   (3)

The quantum information processing apparatus according to (1) or (2), wherein the quantum module is formed by using localized electrons in a solid.

(4)

The quantum information processing apparatus according to any one of (1) to (3), wherein the quantum module is formed by using light emitting point defects having discrete energy levels or a light emitting quantum dot of a semiconductor material.

(5)

The quantum information processing apparatus according to any one of (1) to (4), wherein the quantum modules are arranged in an annular shape.

(6)

The quantum information processing apparatus according to (5), wherein the quantum modules are radially arranged such that an interval becomes wider toward an outer periphery.

(7)

The quantum information processing apparatus according to (5) or (6), wherein the control modules are arranged in an annular shape.

(8)

The quantum information processing apparatus according to any one of (1) to (7), wherein the quantum module array is formed by two-dimensionally arranging two layers of a prime plane and a dual plane of a Raussendorf lattice.

(9)

The quantum information processing apparatus according to any one of (1) to (8), wherein the quantum module includes an optical resonator.

(10)

The quantum information processing apparatus according to any one of (1) to (9), wherein
the control module includes a high-frequency magnetic field application module including
a high-frequency oscillator configured to generate a high-frequency magnetic field pulse, and
a high-frequency waveguide configured to transmit the high-frequency magnetic field pulse.
   (11)

The quantum information processing apparatus according to any one of (1) to (10), wherein
the control module includes a light irradiation module including
a light source configured to generate an electromagnetic wave,
an optical waveguide configured to transmit the electromagnetic wave, and
a concentrator configured to irradiate the selected quantum module with the electromagnetic wave.
   (12)

The quantum information processing apparatus according to any one of (1) to (11), wherein
the control module includes
a remote entanglement forming module configured to perform an operation of forming entanglement between the quantum modules.
   (13)

The quantum information processing apparatus according to (12), wherein
the remote entanglement forming module includes
a single photon source configured to generate a single photon,
a single photon detector configured to detect a single photon,
an optical waveguide configured to transmit a single photon,
a beam splitter configured to demultiplex a single photon of a predetermined frequency, and
a concentrator configured to concentrate a demultiplexed single photon on a pair of the quantum modules forming entanglement.
   (14)

The quantum information processing apparatus according to any one of (1) to (13), further comprising:
a reflectance measurement module including
a single photon source configured to generate a single photon,
a single photon detector configured to detect a single photon reflected from the quantum module and measure a reflectance,
an optical waveguide configured to transmit a single photon, and
a concentrator configured to concentrate a single photon on the quantum module.
   (15)

The quantum information processing apparatus according to any one of (1) to (14), wherein
the driving apparatus includes
a shaft configured to rotate at least one of the quantum module array and the control module, and
a motor configured to rotate the shaft.
   (16)

The quantum information processing apparatus according to any one of (1) to (15), further comprising: a magnetic field application apparatus configured to apply a static magnetic field to the entire quantum module array.

(17)

The quantum information processing apparatus according to any one of (1) to (16), further comprising:
an oscillating magnetic field generating apparatus including
a high-frequency oscillator configured to generate a high-frequency signal, and
a coil configured to generate a uniform alternating magnetic field in at least a part of the quantum module array.
   (18)

The quantum information processing apparatus according to any one of (1) to (17), further comprising: a refrigerator configured to freeze the quantum module array and at least a part of the control module.

(19)

A quantum information processing apparatus system comprising:
a plurality of the quantum information processing apparatuses according to any one of (1) to (18); and
an optical fiber configured to couple the plurality of quantum information processing apparatuses to each other.

### REFERENCE SIGNS LIST

1 distributed error-tolerant quantum computer
2 quantum computer
3 quantum module array
4 control module
5 driving apparatus
6 magnetic field application apparatus
7 oscillating magnetic field generating apparatus
8 refrigerator
9 optical fiber
10 quantum computer
31 quantum module
32 substrate
33 dielectric multilayer film
34 magnetic multilayer film
41 first functional block
42 second functional block
43 third functional block
44 control circuit
45 optical converter array
46 communication interface
311 quantum module to be measured
312 non-operation quantum module
341, 342 magnetic body
421 to 427 remote entanglement forming module
428 high-frequency magnetic field application module
429 light irradiation module
430 reflectance measurement module
4211, 4221 single photon input/output port
4281 high-frequency waveguide
4301 single photon source
4302 single photon detector
4303 concentrator
4304 beam splitter

1. A quantum information processing apparatus comprising:
a quantum module array in which a plurality of quantum modules are arranged in an array;
a control module configured to perform an operation of forming entanglement between the quantum modules and control of measurement of a quantum state of the quantum modules; and
a driving apparatus configured to rotate at least one of the quantum module array and the control module.

2. The quantum information processing apparatus according to claim 1, wherein
the quantum module array includes a magnetic body disposed close to a physical system used as a quantum bit forming the quantum module, and
the control module includes a light irradiation module that irradiates the magnetic body with light to change magnetization and selects the quantum module that operates the quantum state.

3. The quantum information processing apparatus according to claim 1, wherein the quantum module is formed by using localized electrons in a solid.

4. The quantum information processing apparatus according to claim 1, wherein the quantum module is formed by using light emitting point defects having discrete energy levels or a light emitting quantum dot of a semiconductor material.

5. The quantum information processing apparatus according to claim 1, wherein the quantum modules are arranged in an annular shape.

6. The quantum information processing apparatus according to claim 5, wherein the quantum modules are radially arranged such that an interval becomes wider toward an outer periphery.

7. The quantum information processing apparatus according to claim 5, wherein the control modules are arranged in an annular shape.

8. The quantum information processing apparatus according to claim 1, wherein the quantum module array is formed by two-dimensionally arranging two layers of a prime plane and a dual plane of a Raussendorf lattice.

9. The quantum information processing apparatus according to claim 1, wherein the quantum module includes an optical resonator.

10. The quantum information processing apparatus according to claim 1, wherein
the control module includes a high-frequency magnetic field application module including
a high-frequency oscillator configured to generate a high-frequency magnetic field pulse, and
a high-frequency waveguide configured to transmit the high-frequency magnetic field pulse.

11. The quantum information processing apparatus according to claim 1, wherein
the control module includes a light irradiation module including
a light source configured to generate an electromagnetic wave,
an optical waveguide configured to transmit the electromagnetic wave, and
a concentrator configured to irradiate the selected quantum module with the electromagnetic wave.

12. The quantum information processing apparatus according to claim 1, wherein
the control module includes
a remote entanglement forming module configured to perform an operation of forming entanglement between the quantum modules.

13. The quantum information processing apparatus according to claim 12, wherein
the remote entanglement forming module includes
a single photon source configured to generate a single photon,
a single photon detector configured to detect a single photon,
an optical waveguide configured to transmit a single photon,
a beam splitter configured to demultiplex a single photon of a predetermined frequency, and
a concentrator configured to concentrate a demultiplexed single photon on a pair of the quantum modules forming entanglement.

14. The quantum information processing apparatus according to claim 1, further comprising:
a reflectance measurement module including
a single photon source configured to generate a single photon,
a single photon detector configured to detect a single photon reflected from the quantum module and measure a reflectance,
an optical waveguide configured to transmit a single photon, and
a concentrator configured to concentrate a single photon on the quantum module.

15. The quantum information processing apparatus according to claim 1, wherein
the driving apparatus includes
a shaft configured to rotate at least one of the quantum module array and the control module, and
a motor configured to rotate the shaft.

16. The quantum information processing apparatus according to claim 1, further comprising: a magnetic field application apparatus configured to apply a static magnetic field to the entire quantum module array.

17. The quantum information processing apparatus according to claim 1, further comprising:
an oscillating magnetic field generating apparatus including
a high-frequency oscillator configured to generate a high-frequency signal, and
a coil configured to generate a uniform alternating magnetic field in at least a part of the quantum module array.

18. The quantum information processing apparatus according to claim 1, further comprising: a refrigerator configured to freeze the quantum module array and at least a part of the control module.

19. A quantum information processing apparatus system comprising:
a plurality of the quantum information processing apparatuses according to claim 1; and
an optical fiber configured to couple the plurality of quantum information processing apparatuses to each other.
